(19) United States
(12) Patent Application Publication
(10) Pub. No.: US 2016/0266466 A1
(43) Pub. Date: Sep. 15, 2016

(54) WAVEGUIDES, AND SYSTEMS AND METHODS FOR FORMING AND USING SUCH WAVEGUIDES

(71) Applicant: UNIVERSITY OF MARYLAND, COLLEGE PARK, College Park, MD (US)

(72) Inventors: Howard M. Milchberg, Potomac, MD (US); Jared Wahlstrand, Silver Spring, MD (US); Nihal Jhajj, Hyattsville, MD (US); Eric Rosenthal, Hyattsville, MD (US)

(21) Appl. No.: 15/033,765

(22) PCT Filed: Nov. 7, 2014
(86) PCT No.: PCT/US14/64480

§ 371 Date: May 2, 2016

Related U.S. Application Data
(60) Provisional application No. 61/901,186, filed on Nov. 7, 2013.

(51) Int. Cl. G02F 1/35; H01S 3/00

(52) U.S. Cl. CPC G02F 1/3511; H01S 3/005

(57) ABSTRACT

Nonlinear absorption of a sub-picosecond laser pulse is used to generate one or more spatially elongated heated gas volumes. Transient density variations caused by the spatially elongated heated gas volumes provide a refractive index profile capable of guiding electromagnetic radiation through the gas. The waveguide structure in the gas is disposed between the spatially elongated heated gas volumes and results from interaction between acoustic waves generated by the spatially elongated heated gas volumes or from a non-uniform thermal gas profile caused by the spatially elongated heated gas volumes. The nonlinear absorption can be repeated at regular intervals in time and space to renew the waveguide in the gas, thereby allowing for the guiding of high average power radiation (e.g., megawatts) that is well below self-focusing or stimulated Raman scattering thresholds. The spatially elongated heated gas volumes can be generated using remote focusing of sub-picosecond laser pulses and/or multiple sub-picosecond filaments.

### CROSS-REFERENCE TO RELATED APPLICATIONS

The present application claims the benefit of U.S. Provisional Application No. 61/901,186, filed Nov. 7, 2013, which is hereby incorporated by reference herein in its entirety.

### STATEMENT REGARDING FEDERALLY SPONSORED RESEARCH

This invention was made with government support under FA95501310044 awarded by the Air Force Office of Scientific Research (AFOSR). The government has certain rights in the invention.

### FIELD

The present disclosure relates generally to waveguides, and, more particularly, to waveguides formed in a gas, such as air, and systems and methods for forming and using such waveguides.

### BACKGROUND

Long range filamentation of intense femtosecond laser pulses in gases is an area of increasing interest, as it combines exciting potential applications with fundamental nonlinear optical physics. As shown in FIGS. 1A-1B, an intense pulse 102 (e.g., having a pulse length τ less than 1 ps, for example around 100 fs or less) propagating in a transparent medium (e.g., air) induces a positive nonlinear correction to the refractive index that co-propagates with the pulse as a self-lens. Once the laser pulse peak power exceeds a critical value, typically P>P_{cr}˜5-10 GW in air, the self-induced lens overcomes diffraction and focuses the beam, leading to plasma generation and beam defocusing when the gas ionization intensity threshold is exceeded. The dynamic interplay between self-focusing and defocusing leads to self-sustained propagation of a tightly radially confined high intensity region (i.e., a filament 104) accompanied by plasma of diameter <100 μm over distances greatly exceeding the optical Rayleigh range. Such filaments can extend from millimeters to hundreds of meters (e.g., along a direction of propagation 106), depending on the medium and laser parameters.

It remains a significant limitation that femtosecond filamentation cannot deliver high average power over long distances in a single tight spatial mode. This is due to the fact that for laser pulses having a peak power on the order of several P_{cr}, the beam will collapse into multiple filaments with shot-to-shot variation in their transverse location. For P_{cr}˜5-10 GW, this means that single filament formation requires pulses of order ˜1 mJ. For a 1 kHz pulse repetition rate laser, this represents only 1 W of average power.

### SUMMARY

Systems, methods, and devices for generating a waveguide structure in a gas, such as air, are disclosed herein. In some embodiments, a plurality of laser pulses is nonlinearly absorbed by a gas to generate respective spatially elongated heated gas volumes transversely spaced apart from each other. Transient density variations caused by the spatially elongated heated gas volumes provide a refractive index profile capable of guiding electromagnetic radiation through the gas. For example, the waveguide structure in the gas is disposed between the spatially elongated heated gas volumes and results from interaction between acoustic waves generated by the spatially elongated heated gas volumes or from a non-uniform thermal gas profile caused by the spatially elongated heated gas volumes. The nonlinear absorption can be repeated at regular intervals to renew the waveguide in the gas, thereby allowing for the guiding of high average power radiation (e.g., on the order of megawatts) that is well below self-focusing or stimulated Raman scattering thresholds. In other embodiments, a single spatially elongated heated gas volume is used as a waveguide by appropriate timing between the guided radiation and the laser pulse forming the heated gas volume. The spatially elongated heated gas volumes can be generated using remote focusing of sub-picosecond laser pulses and/or multiple sub-picosecond filaments.

In one or more embodiments, a method comprises directing a plurality of propagating laser pulses through a gas. Each of the propagating pulses can be formed from the same laser beam or from separate laser beams. The propagating pulses are nonlinearly absorbed by the gas to generate respective spatially elongated heated gas volumes transversely spaced apart from each other. The directing is such that a waveguide is formed in the gas at a location between the heated gas volumes and such that each laser pulse has or is concentrated to have an intensity causing the nonlinear absorption thereof by the gas.

In one or more embodiments, a system comprises at least one laser and an optical system. The at least one laser generates sub-picosecond laser pulses. The optical system can direct the pulses from the at least one laser through a gas such that each laser pulse has or is concentrated to have an intensity causing nonlinear absorption by the gas so as to generate respective spatially elongated heated gas volumes transversely spaced apart from each other.

In one or more embodiments, a waveguide is formed by directing a plurality of propagating sub-picosecond laser pulses through a gas. The pulses can be nonlinearly absorbed by the gas to generate respective spatially elongated heated gas volumes transversely spaced from each other. The waveguide can comprise a core region of the gas and an outer region of the gas (e.g., an annular region). The outer region of the gas can surround the core region and can have a density less than that of the core region. The waveguide can be formed by interaction between acoustic waves generated by the spatially elongated heated gas volumes or by a non-uniform thermal gas profile caused by the spatially elongated heated gas volumes.

In one or more embodiments, a method can comprise generating a first spatially elongated heated volume in a gas by nonlinear absorption of at least one laser pulse. The method can further include using a non-uniform density profile in the gas as a waveguide for electromagnetic radiation. The density profile can be caused, at least in part, by the first spatially elongated heated volume.

Objects and advantages of embodiments of the disclosed subject matter will become apparent from the following description when considered in conjunction with the accompanying drawings.

### BRIEF DESCRIPTION OF DRAWINGS

Embodiments will hereinafter be described with reference to the accompanying drawings, which have not necessarily been drawn to scale. Where applicable, some features may not be illustrated to assist in the illustration and description of underlying features or have been exaggerated in order to assist in their illustration and description. Throughout the figures, like reference numerals denote like elements.

FIG. 1A shows a femtosecond laser pulse creating a filament in a gas.

FIG. 1B is a view of the femtosecond filament of FIG. 1A along a direction of propagation.

FIG. 2 shows acoustic and thermal effects in a gas caused by an elongated heated gas volume resulting from nonlinear absorption of a laser pulse, according to one or more embodiments of the disclosed subject matter.

FIG. 3A shows a system for remote focusing and scanning of laser pulses through a gas to generate an elongated heated gas volume via nonlinear absorption of the laser pulses, according to one or more embodiments of the disclosed subject matter.

FIG. 3B shows a system for scanning a focal volume through a gas to generate a curved, elongated heated gas volume via nonlinear absorption of laser pulses, according to one or more embodiments of the disclosed subject matter.

FIG. 4 shows a system for directing a filament through a gas to generate an elongated heated gas volume via nonlinear absorption of the filament, according to one or more embodiments of the disclosed subject matter.

FIG. 5 is a graph of hydrodynamic simulations of the density profile in 1 atm of nitrogen for various times after passage of a femtosecond filament.

FIG. 6 shows gas dynamics following a single filament in air, with the top row 502 being interferometric measurements of refractive index change following a short pulse as a function of the time delay of the probe pulse and the bottom row 504 being hydrodynamic simulations assuming a 60 μm full width half maximum (FWHM) Gaussian heat source having a peak initial density of 32 mJ/cm³.

FIG. 7 is a graph of hydrodynamic simulations of the density profile in 1 atm of nitrogen for various times greater than 60 μs after passage of a femtosecond filament.

FIG. 8A are graphs of gas average number density profiles versus probe delay with respect to a femtosecond filament focused at f/65 into air at 1 atm.

FIG. 8B are lineout graphs of the air density profiles illustrated in FIG. 8A.

FIG. 9A shows acoustic and thermal effects in a gas caused by multiple elongated heated gas volumes resulting from nonlinear absorption of respective laser pulses, according to one or more embodiments of the disclosed subject matter.

FIG. 9B shows resulting waveguide features using an array of four elongated heated gas volumes, according to one or more embodiments of the disclosed subject matter.

FIG. 10A shows a system for scanning a focal volume through a gas to generate an elongated heated gas volume via nonlinear absorption of laser pulses, according to one or more embodiments of the disclosed subject matter.

FIG. 10B shows a system for scanning a beam collapse location for successive filaments to form a longer filament that generates an elongated heated gas volume, according to one or more embodiments of the disclosed subject matter.

FIG. 11 shows an optical setup for generating four femtosecond filaments and an interferometry detection system, according to one or more embodiments of the disclosed subject matter.

FIG. 12 are graphs of interferometric measurements illustrating the air density evolution following four femtosecond filaments at different times using the setup of FIG. 11.

FIG. 13A is an image (left) of the probe beam imaged after a filamentation region without four filaments and an image (right) of the probe beam imaged after the filamentation region using an array of four filaments, according to one or more embodiments of the disclosed subject matter.

FIG. 13B is an image illustrating the shadow of the thermal waveguide generated by an array of four filaments, according to one or more embodiments of the disclosed subject matter.

FIG. 14 is a graph of coupling efficiency versus probe delay for a thermal waveguide generated by an array of four filaments, according to one or more embodiments of the disclosed subject matter.

FIG. 15 is a time series of images showing the probe beam after the exit of the air waveguide generated after an array of four filaments, according to one or more embodiments of the disclosed subject matter.

FIG. 16 are graphs (top row) of the index of refraction shift as a function of time produced by a temperature profile induced by an array of four filaments and graphs (bottom row) of a beam propagation method (BPM) simulation of the guided laser profile at the end of the waveguide produced by the refractive index change induced by the array of four filaments, according to one or more embodiments of the disclosed subject matter.

FIGS. 17A-17D show resulting waveguide features using a pair of elongated heated gas volumes, an array of three elongated heated gas volumes, a circular array of eight elongated heated gas volumes, and an elliptical array of eight heated elongated gas volumes, respectively, according to one or more embodiments of the disclosed subject matter.

FIG. 18 is an image of an eight lobe beam focus used to produce an array of eight femtosecond filaments, according to one or more embodiments of the disclosed subject matter.

FIG. 19 shows a measured refractive index profile for an array of eight femtosecond filaments (left panel), a hydrocode simulation of the refractive index profile for the array of eight femtosecond filaments (middle panel), and an index profile simulation for a larger transverse scale typical of axially extended air waveguides, according to one or more embodiments of the disclosed subject matter.

FIG. 20 shows interferometrically measured refractive index profiles following an array of eight femtosecond filaments for different times (top row) and a simulated evolution of refractive index profiles following an array of eight femtosecond filaments (bottom row), according to one or more embodiments of the disclosed subject matter.

FIG. 21 is a schematic diagram of a generalized setup for conveying electromagnetic radiation from a source using a waveguide in a gas formed by an array of femtosecond filaments, according to one or more embodiments of the disclosed subject matter.

FIG. 22 is a schematic diagram of a generalized setup for conveying electromagnetic radiation from a source using a waveguide in a gas formed by remote focusing and scanning of laser pulses, according to one or more embodiments of the disclosed subject matter.

FIG. 23 is a schematic diagram of a generalized setup for detecting electromagnetic radiation from a source using a waveguide in a gas formed by an array of femtosecond filaments, according to one or more embodiments of the disclosed subject matter.

FIG. 24A shows an experimental setup for demonstration of light collection and transport by an air waveguide formed by an array of femtosecond filaments, according to one or more embodiments of the disclosed subject matter.

FIG. 24B is a close-up simplified view showing interaction of the air waveguide with the spark source of FIG. 24A.

FIG. 25 shows single-shot images of the breakdown spark light emerging from the exit of waveguide induced by a single filament at 1.2 μs (top row, left panel), a waveguide induced by an array of four femtosecond filaments at 3.2 μs (top row, center panel), a waveguide induced by an array of eight femtosecond filaments at 1.4 μs (top row, right panel), a waveguide induced by an array of four femtosecond filaments at 250 μs (bottom row, left panel), and a waveguide induced by an array of eight femtosecond filaments at 100 μs (bottom row, right panel), according to one or more embodiments of the disclosed subject matter.

FIG. 26 shows graphs of source collection enhancement and peak signal enhancement versus filament-spark source delay for a waveguide induced by a single filament in the acoustic regime (top row, left panel), a waveguide induced by an array of four filaments in the acoustic regime (top row, center panel), a waveguide induced by an array of eight filaments in the acoustic regime (top row, right panel), a waveguide induced by an array of four filaments in the thermal regime (bottom row, left panel), and a waveguide induced by an array of eight filaments in the thermal regime (bottom row, right panel).

FIG. 27 is a schematic illustration of a waveguide maintained in a gas by periodic repetition of laser pulses, according to one or more embodiments of the disclosed subject matter.

FIG. 28 is a process flow diagram for generating and using a waveguide in a gas, according to one or more embodiments of the disclosed subject matter.

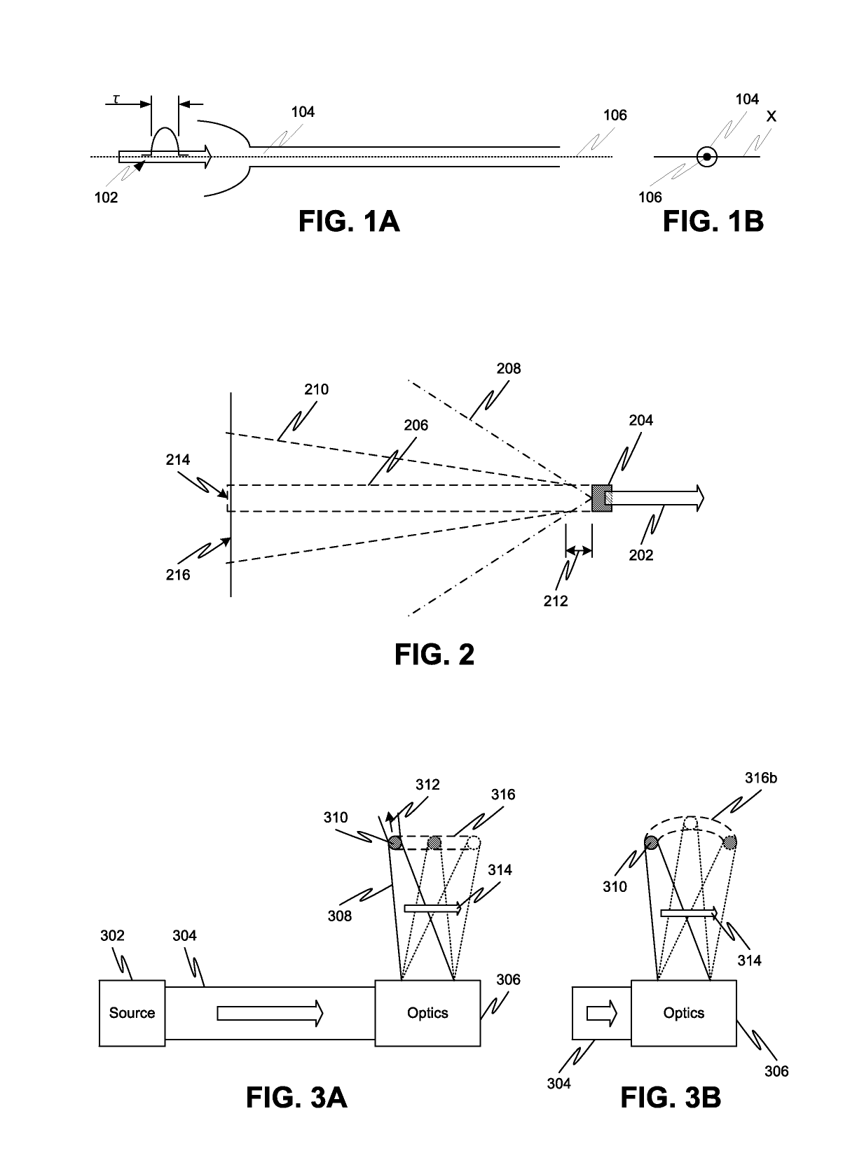

### DETAILED DESCRIPTION

Systems, methods, and devices for generating a waveguide structure in a gas, such as air, are disclosed herein. One or more short laser pulses (e.g., less than 1 ps), each having or being concentrated to have a sufficiently high intensity, are directed through and nonlinearly absorbed by a gas (i.e., different from linear absorption since it is proportional to the higher orders of the intensity rather than the first order) to form one or more spatially elongated heated gas volumes. The resulting one or more heated gas volumes can cause transient density variations in the gas that provide a refractive index profile capable of guiding electromagnetic radiation through the gas. The one or more short laser pulses can be in the form of remotely focused sub-picosecond laser pulses and/or sub-picosecond filaments.

In some embodiments, a plurality of laser pulses is simultaneously directed through the gas to generate respective spatially elongated heated gas volumes spaced apart from each other. The resulting waveguide structure (based on an induced refractive index profile between the heated gas volumes) results from interaction between acoustic waves generated by the laser pulse absorption or from a non-uniform thermal gas profile (or non-uniform density profile) caused by the spatially elongated heated gas volumes. The nonlinear absorption can be repeated at regular intervals to renew the waveguide in the gas, thereby allowing for the guiding of high average power radiation (e.g., on the order of megawatts) that is well below self-focusing or stimulated Raman scattering thresholds.

In other embodiments, each spatially elongated heated gas volume itself can be used as a waveguide. Referring to FIG. 2, a sub-picosecond laser pulse 204 is directed along a direction of propagation 202 through a gas. The laser pulse 204 can have a sufficient intensity to cause nonlinear absorption of the pulse by the gas as the pulse propagates therethrough. For example, the laser pulse 204 can have, or be concentrated to have, an intensity of at least 10¹² W/cm², although other intensity values capable of nonlinear absorption of a laser pulse may also be possible. Following the laser pulse 204, a spatially elongated heated gas volume 206 is produced by the nonlinear absorption of the laser pulse 204. The resulting heated gas volume 206 forms a gas density depression or hole that grows once the laser pulse 204 has been at least partially absorbed by or propagated past the particular portion of the volume. This gas density hole grows over several hundred nanoseconds. Over the same timescale, a single cycle acoustic wave 208 is launched and begins to propagate outward from the heated gas volume 206. The density depression or “hole” then decays by thermal diffusion 210 over milliseconds leading to a non-uniform density profile in the gas, with an inner region 214 of relatively lower density that includes the heated gas volume 206 and an outer region 216 of relatively higher density.

The timing between injection of the guided radiation and the laser pulse 204 forming the heated gas volume 206 can be controlled to take advantage of a short (e.g., less than 1 μs in air) temporal window 212 following the laser pulse where the positive density crest of a single cycle acoustic wave 208 launched by the absorption of the laser pulse is used to guide light. After this window, the density hole (e.g., the inner region 214) formed by the heated gas volume 206 acts to defocus any light that may be injected along the direction of propagation 202. For example, a second pulse can be directed through the heated gas volume at a time, tᵢ, after the laser pulse 204 is first directed or absorbed by the gas, where

$${t}_{i} < \frac{{w}_{0}}{{c}_{s}} ,$$

w₀ is a spot size of the second pulse, and cₛ is the speed of sound in the gas.

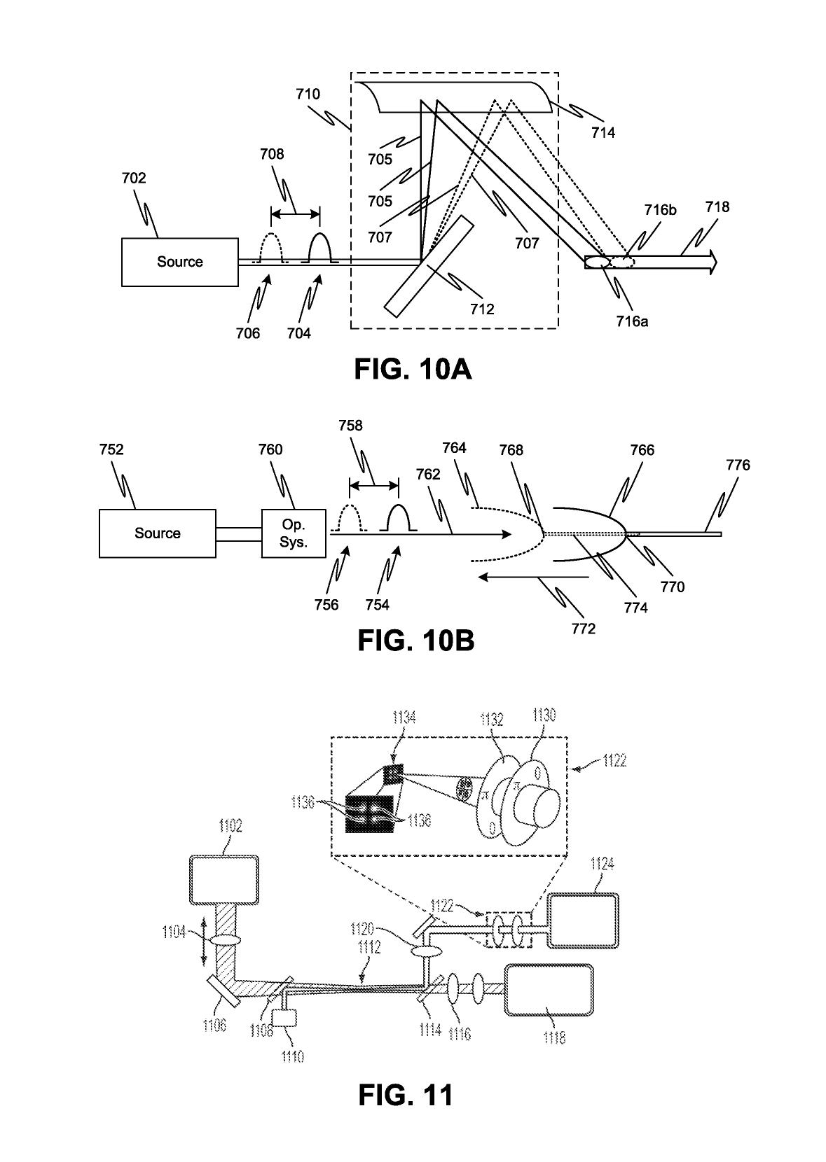

The laser pulse 204 can be in the form of a remotely focused sub-picosecond laser pulse and/or a sub-picosecond filament. For example, a system for remote focusing and scanning of laser pulses is shown in FIG. 3A. A laser source 302 can generate a sub-picosecond laser pulse 304 (shown as a continuous beam for illustration purposes only) having a first intensity. The laser pulse 304 can be directed to an optical system 306 (e.g., a diffraction grating, cylindrical lens or mirror, and/or a spatial light modulator, as discussed with respect to FIG. 10A below). The optical system 306 can focus the input laser pulse 304 into a focused beam 308 with a direction of propagation 312 and a focal volume 310 (i.e., with a minimum beam waist) at a location in the gas remote from the optical system 306 and/or the source 302. As a result of the focusing, the focal volume 310 can have a second intensity, which may be greater than the first intensity, that results in nonlinear absorption of the laser pulse by the gas.

The optical system 306 can further scan the focal volume 310 to different locations in the gas over time, for example, by moving the focal volume 310 along a scanning direction 314 to form a spatially elongated heated gas volume 316. Although shown as a substantially straight volume 316 in FIG. 3A, it is also possible for the optical system 306 to change the distance of the focal volume 310 concurrently with or separate from the scanning along direction 314 to create a spatially elongated heated gas volume 316b that is curved along at least a portion of its length, as shown in FIG. 3B. More complex curvilinear patterns for the elongated heated gas volume other than those specifically illustrated in FIGS. 3A-3B are also possible by appropriate control of focal depth and/or scanning direction, or by implementing optics for Airy beams.

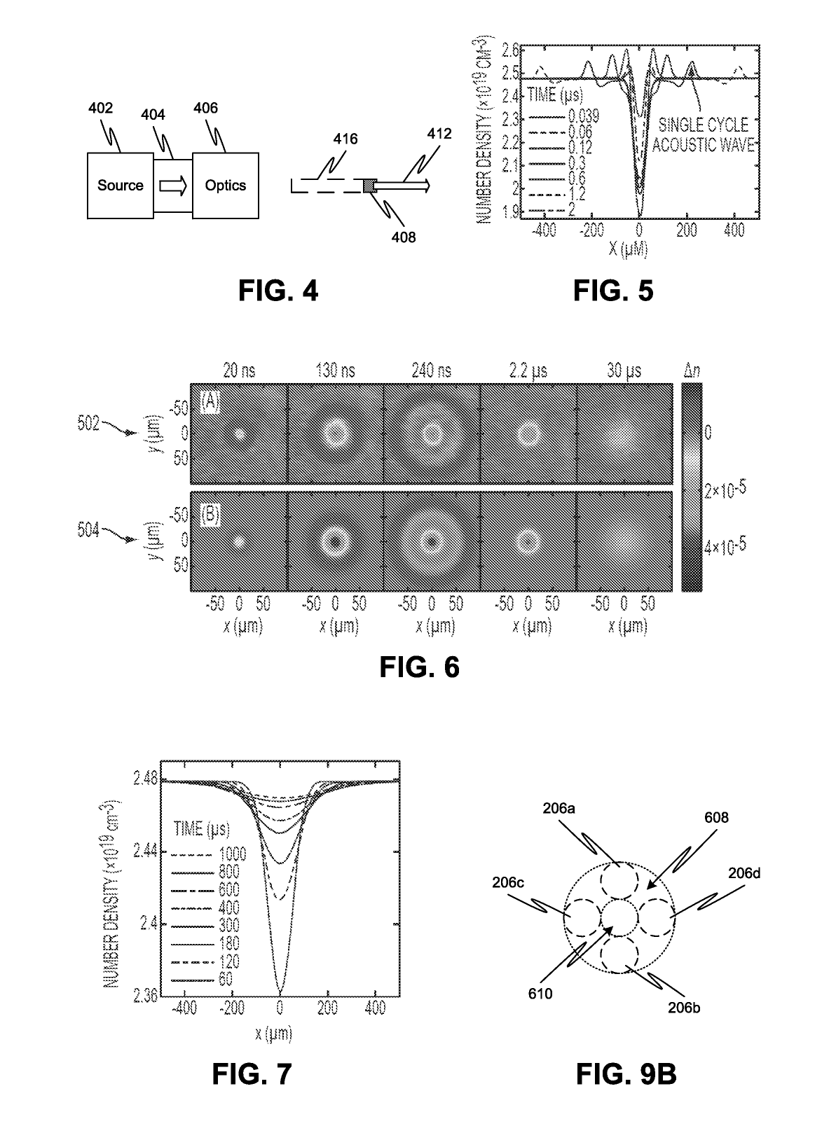

In another example, a system for producing a heated gas volume via filamentation is shown in FIG. 4. A laser source 402 can generate a sub-picosecond laser pulse 404 (shown as a continuous beam for illustration purposes only). Optionally, the laser pulse 404 can be directed to an optical system 406 (e.g., a phase shifting apparatus, dielectric mirror, and/or focusing lens system, as discussed with respect to FIG. 11 below). The optical system 406 can direct the input laser pulse 404 along a direction of propagation 412 to form a filament 408. As used herein, the term “filament” (or the process of “filamentation”) refers to the dynamic structure with an intense core that results from the interplay between self-focusing induced by bound electron nonlinearity in the atoms or molecules of the gas (i.e., the Kerr effect) and defocusing from plasma generated by a sub-picosecond laser pulse and that is capable of propagating over extended distances much larger than the typical diffraction length while keeping a narrow beam size (e.g., 50-100 μm) without the help of any external guiding mechanism.

The intensity of the filament 408 can exceed, for example, 10¹² W/cm², although other intensity values capable of causing nonlinear absorption of the filament may also be possible. Unique to sub-picosecond filaments 408 is their extended high intensity propagation over many Rayleigh lengths and their ultrafast nonlinear absorption in the gas, stored in plasma and atomic and molecular excitation, which creates an axially extended impulsive pressure source to drive gas hydrodynamics. The nonlinear absorption of the filament 408 by the gas as it propagates along direction 412 forms a spatially elongated heated gas volume 416 in its wake and substantially aligned with the direction of propagation 412 (i.e., the direction of elongation of the gas volume 416 is the same as the direction of propagation 412 of the filament 408).

As noted above, the spatially elongated heated gas volume 316 in FIG. 3A (or 316b in FIG. 3B) or 416 in FIG. 4, can be used to guide electromagnetic radiation in an appropriate time window following the nonlinear absorption of the sub-picosecond laser pulse. In particular, guiding is enabled by confining light in the positive density (refractive index) crest of the single cycle annular acoustic wave 208 launched following nonlinear absorption of the sub-picosecond laser pulse 204. The optical properties of the spatially elongated heated gas volumes depend on the evolving gas density profile, which is determined by the axial and transverse distribution of energy deposited in the gas by the nonlinearly absorbed laser pulse.

For example, in a single femtosecond filament in air at standard conditions, energy is absorbed through ionization and two-photon excitation of rotational states. For typical pulse durations of ˜40-100 fs, approximately 25 mJ/cm³ is deposited over the ˜50 μm radius filament core by plasma generation and molecular rotational excitation. The hydrodynamic response of air to this pressure impulse leads, over a ˜100 ns timescale, to the formation of an outgoing, single cycle cylindrical acoustic wave, which leaves behind a region of hot air and a corresponding density depression. The density depression or “hole” then decays by thermal diffusion over milliseconds. The refractive index profile enabling air waveguiding is related to the change in density Δn/(n₀˜1)=Δρ/ρ₀, where Δn is the change in refractive index, n₀−1=2.8×10⁻⁴ is the index of refraction of air at ambient density ρ₀, and Δρ is the change in density.

FIG. 5 shows simulation results in 1 atm nitrogen (N₂) capturing the dynamics at various times less than 10 μs after a laser pulse. FIG. 6 shows higher time resolution measurements 502 of the 2D density hole evolution (expressed as air refractive index shift) of a short air filament from nanoseconds through microseconds after filament formation and corresponding hydrodynamic simulations 504. The filament plasma recombines to a neutral gas on a ˜10 ns timescale and the molecular excitation thermalizes. Owing to the finite thermal conductivity of the gas, the initial energy invested in the filament is still contained in a small radial zone, but it is repartitioned into the translational and rotational degrees of freedom of the neutral gas. The result is an extended and narrow high pressure region at temperatures up to a few hundred K above ambient. In air, this pressure source launches a radial sound wave ˜100 ns after the filament is formed, as shown in FIG. 5. By ˜1 μs, the gas reaches pressure equilibrium with an elevated temperature and reduced gas density in the volume originally occupied by the filament, after which the “density hole” decays by thermal diffusion on a few millisecond timescale. By ˜2 μs, a quasi-stationary density hole is established. For longer time scales, thermal diffusion dominates. FIG. 7 shows simulation results for times up to 1 ms for the same conditions as in FIG. 5.

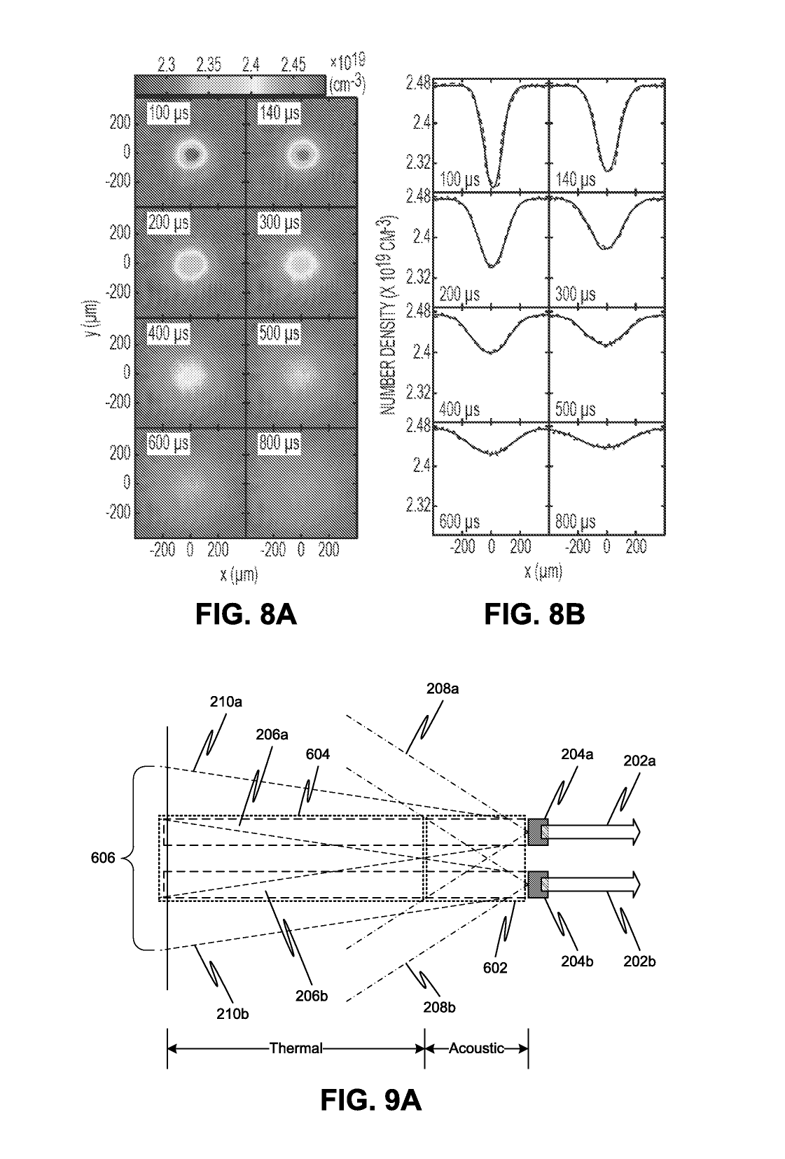

The effect of the long timescale gas density hole left by a pulse or sequence of pulses is to reduce the index of refraction near the center of the beam seen by the next pulse in the sequence. This will have a defocusing effect (i.e., a negative lens) on the pulse. FIG. 8A shows a sequence of 2D density profiles for a pump energy of 0.7 mJ at a repetition rate of 1 kHz in air at 1 atm, and FIG. 8B are plots of central lineouts of refractive index shifts for the profiles in FIG. 8A. The index perturbation can be as high as Δn/δn˜20%.

Although a single spatially elongated heated gas volume eventually results in a beam-defocusing gas-density hole, a guiding structure can be formed in the gas using judicious placement of more than one spatially elongated heated gas volumes. Inspection of the time-varying density profiles resulting from nonlinear absorption of a sub-picosecond laser pulse shows that there are two regimes in the gas dynamical evolution that can enable guiding of secondary electromagnetic radiation. Acoustic guiding (also referred to herein as the “acoustic regime,” “acoustic guiding regime,” or an “acoustic waveguide”) can occur over a short timescale interval (e.g., on the order of 1 μs in air) and works by confining electromagnetic radiation in the enhanced density peak resulting from collision of acoustic waves from multiple heated gas volumes transversely spaced from each other (i.e., spaced from each other in a transverse direction perpendicular to, or at least crossing, the direction of elongation of the heated gas volumes). Thermal guiding (also referred to herein as the “thermal regime,” “thermal guiding regime,” or a “thermal waveguide”) can occur over a relatively larger timescale interval (e.g., on the order of 1 ms in air) and works by confining electromagnetic radiation in a core of near ambient gas density surrounded by a cladding region or moat of diffusively merged density holes formed by the multiple heated gas volumes.

Referring to FIGS. 9A-9B, an array of four sub-picosecond laser pulses can be used to form a waveguide structure. In FIG. 9A, only two of the laser pulses 204a, 204b are shown. Each of the laser pulses 204a, 204b are directed along a respective direction of propagation 202a, 202b through a gas. Each laser pulse 204a, 204b can have a sufficient intensity to cause nonlinear absorption of the pulse by the gas as it propagates therethrough. For example, each laser pulse can have or be concentrated to have (e.g., by remote focusing or via filamentation) an intensity of at least 10¹² W/cm², although other intensity values capable of nonlinear absorption of a laser pulse may also be possible. Following each laser pulse 204, a respective spatially elongated heated gas volume 206 (e.g., 206a-206d, as shown in FIG. 9B) can be produced by the nonlinear absorption of the corresponding laser pulse 204. The resulting heated gas volumes 206a-206d form a gas density depression or hole that grows once the laser pulse 204a-d has been at least partially absorbed by or propagated past the particular portion of the volume. This gas density hole grows over several hundred nanoseconds. Over the same timescale, acoustic waves (e.g., 208a, 208b in FIG. 9A) are launched from each heated gas volume 206. The density depression or “hole” then decays by thermal diffusion (e.g., 210a, 210b in FIG. 9A) over milliseconds leading to a non-uniform density profile 606 in the gas.

The colliding acoustic waves (e.g., 208a, 208b in FIG. 9A) launched from the heated gas volumes 206a-206d form a fiber-like guiding structure with a gas density (or refractive index) enhancement in the center or core region 610. The waveguide structure in the gas in the acoustic regime 602 can last on the order of, for example, microseconds in air. On timescales after the acoustic response, the residual gas density holes formed by the elongated heated gas volumes 206a-206d thermally relax and spread over time (e.g., milliseconds in air), forming a non-uniform density profile 606 following the laser pulses 204. In particular, the density profile includes an outer region 608 or moat (e.g., cladding) of relatively lower gas density surrounding an inner core region 610 of higher gas density. The outer region 608 can include the heated gas volumes 206a-206d as well as circumferential regions therebetween. The waveguide structure in the gas in the thermal regime 604 can last on the order of, for example, milliseconds in air. The heated gas volumes 206a-206d can be elongated in a direction of guiding of electromagnetic radiation, which may coincide with (i.e., be substantially parallel to) a direction of propagation of the laser pulses 204 (e.g., when the laser pulses are filaments) or crossing a direction of propagation of the laser pulses 204 (e.g., when the laser pulses are remotely focused).

For example, the array of elongated heated gas volumes may be formed by remotely focusing and scanning sub-picosecond laser pulses through the gas. An example of such a system is shown in FIG. 10A. A laser source 702 can generate a series of laser pulses, of which a first laser pulse 704 and a second laser pulse 706 are illustrated in FIG. 10A. Each laser pulse can be separated from the successive laser pulse by a time 708, e.g., time τ₁. The laser pulses from the source 702 can be processed by an optical system 710, which focuses and/or scans the laser pulses along a direction of elongation 718. For example, the optical system 710 can include a diffraction grating 712 that redirects the incoming pulses onto a cylindrical mirror 714. The cylindrical mirror 714 can redirect the laser pulses to a desired focal volume. Other optical elements, such as, but not limited to spatial light modulators, focusing lenses, and wavelength filters may be provided as part of the optical system 710. Other optical systems for remote focusing and/or scanning are also possible according to one or more contemplated embodiments, for example, an optical arrangement using a spherical mirror or an arrangement using optical elements to produce Airy beams.

Each successive pulse can have a center bandwidth shifted further to one end of the light spectrum than the previous pulse (e.g., successive pulses having increasingly red-centered bandwidths). The pulse to pulse bandwidth adjustment can be performed, for example, with a spatial light modulator (not shown). For example, for a blue to red shift, successive pulses diffract off diffraction grating 712 at increasing angles, as schematically illustrated by rays 705 for pulse 704 and rays 707 for pulse 706 in FIG. 10A. Diffraction and reflection of the first laser pulse 704 results in a first focal volume 716a. Diffraction and reflection of the second laser pulse 706 results in a second focal volume 716b spaced from the first focal volume 716a. Thus, the cylindrical mirror 714 focuses the laser pulses increasingly downstream as the center wavelength thereof shifts, creating a flying line focus with successive line foci 716a, 716b spatially overlapping. As the laser pulses are nonlinearly absorbed by the gas at respective focal volumes 716a, 716b, an elongated heated gas volume is generated, with a direction of elongation being the same as the scanning direction 718. For a red to blue shift, the focus can scan in a direction opposite to direction 718 illustrated in FIG. 10A.

Although generation of only a single spatially elongated heated gas volume is discussed with respect to the system illustrated in FIG. 10A, the system can be extended to simultaneously produce multiple elongated heated gas volumes spaced from each other. For example, by dividing laser pulses from the laser source 702 into multiple pulses and using optical system 710 to simultaneously generate and scan multiple foci 716 spaced from each other. Alternatively or additionally, multiple laser sources 702 can be provided and used with a single optical system 710 to simultaneously generate and scan multiple foci 716. In still another example, the system illustrated in FIG. 10A can be duplicated as needed, each synced together and producing a respective flying line focus spaced from the other flying line foci. Other configurations will be readily apparent to one of ordinary skill in the applicable arts.

In another example, the array of elongated heated gas volumes may be formed by scanning a beam collapse location for successively generated filaments. An example of such a system is shown in FIG. 10B. A laser source 752 can generate a series of laser pulses, of which a first laser pulse 754 and a second laser pulse 756 are illustrated in FIG. 10B. Optionally, an optical system 760 (e.g., mirrors, lenses, etc.) can receive the laser pulses from the laser source 752 and focus and/or direct the pulses along a desired direction of propagation 762 through the gas. Each laser pulse can be separated from the successive laser pulse by a time 758, e.g., time τ₁.

Successive short pulses separated by the time τ₁ can be increasingly positively chirped, for example. For example, pulse 754 may be more negatively chirped while pulse 756 may be more positively chirped. The pulse to pulse chirp adjustment can be performed, for example, using a spatial light modulator. Pulse 754 collapses from beam shape 766 at point 770 to form a first filament 776 while pulse 756 collapses from beam shape 764 at point 768 to form a second filament 774. Because of the change in the chirping, the beam collapse point 768 for the second pulse 756 is closer to the source 752 than the beam collapse point 770 for the first pulse 754. Thus, successive pulses collapse and form filaments increasingly closer to the source 752, as illustrated by arrow 772, thereby creating a concatenated sequence of shorter filaments forming a longer filament. In other words, the first pulse in the sequence would collapse farthest from the source 752 while the last pulse in the sequence would collapse closest to the source 752. Thus, shorter lengths of filaments, created by a sequence of pulses, can be used to form a longer filament. The timing sequence may also be reversed such that the sequence of concatenations moves away from the source 752 (i.e., the propagation direction 762 and the concatenated sequence direction 772 can be the same).

As the filaments 774, 776 are nonlinearly absorbed by the gas, an elongated heated gas volume is generated, with a direction of elongation being the same as the direction of propagation 762. Although generation of only a single spatially elongated heated gas volume is discussed with respect to the system illustrated in FIG. 10B, the system can be extended to simultaneously produce multiple elongated heated gas volumes transversely spaced from each other. For example, by dividing laser pulses from the laser source 752 into multiple pulses and using optical system 760 to simultaneously generate filaments transversely spaced from each other. Alternatively or additionally, multiple laser sources 742 can be provided and used with a single optical system 760 to simultaneously generate and scan multiple filaments. In still another example, the system illustrated in FIG. 10B can be duplicated as needed, each synced together and producing a respective sequence of concatenated filament collapses transversely spaced from the other sequence of concatenated filament collapses. Other configurations will be readily apparent to one of ordinary skill in the applicable arts.

In another example, the array of elongated heated gas volumes may be formed by an array of filaments, for example, an array of four filaments that are spaced apart from each other in a plane perpendicular to their direction of propagation. Each filament generates an elongated heated gas volume 206 in its wake, as illustrated in FIGS. 9A-9B. For example, a phase shifting apparatus can be used to convert a single pulse into the desired array of filaments. Referring to FIG. 11, a phase shifting optical system 1122 can include a first half pellicle 1130 and a second half pellicle 1132 serially arranged and orthogonal to each other so as to phase-shift the laser electric field from laser source 1124 (e.g., a Ti:Sapphire laser) as shown in each near-field beam quadrant. Below the filamentation threshold, the resulting focused beam at its waist has a 4-lobed intensity profile as shown at 1134, corresponding to a Hermite-Gaussian TEM₁₁ mode, where the electric fields in adjacent lobes are π phase shifted with respect to each other. Above the threshold, the lobes collapse into separate co-propagating filaments 1136. The phase-shifted beam (comprising the sub-picosecond laser pulse) from the laser source 1124 is directed via focusing lenses 1120 and dielectric mirror 1114 (e.g., an 800 nm mirror) through a gas so as to form an array 1112 of four filaments.

Injection and guiding experiments were performed using the experimental setup illustrated in FIG. 11. A secondary radiation source 1102 (e.g., a 532 nm laser) was used to inject secondary electromagnetic radiation along the waveguide formed by the array 1112 of filaments via adjustable probe focusing lens 1104 and mirror 1106. Another dielectric mirror 1108 can be used to direct the array 1112 of filaments to a beam dump 1110 to avoid any damage to the secondary radiation source 1102. The guided secondary radiation can pass through dielectric mirror 1114 and can be imaged onto a detector 1118 (e.g., a folded wavefront interferometer) by a lens system (e.g., relay-imaging lenses).

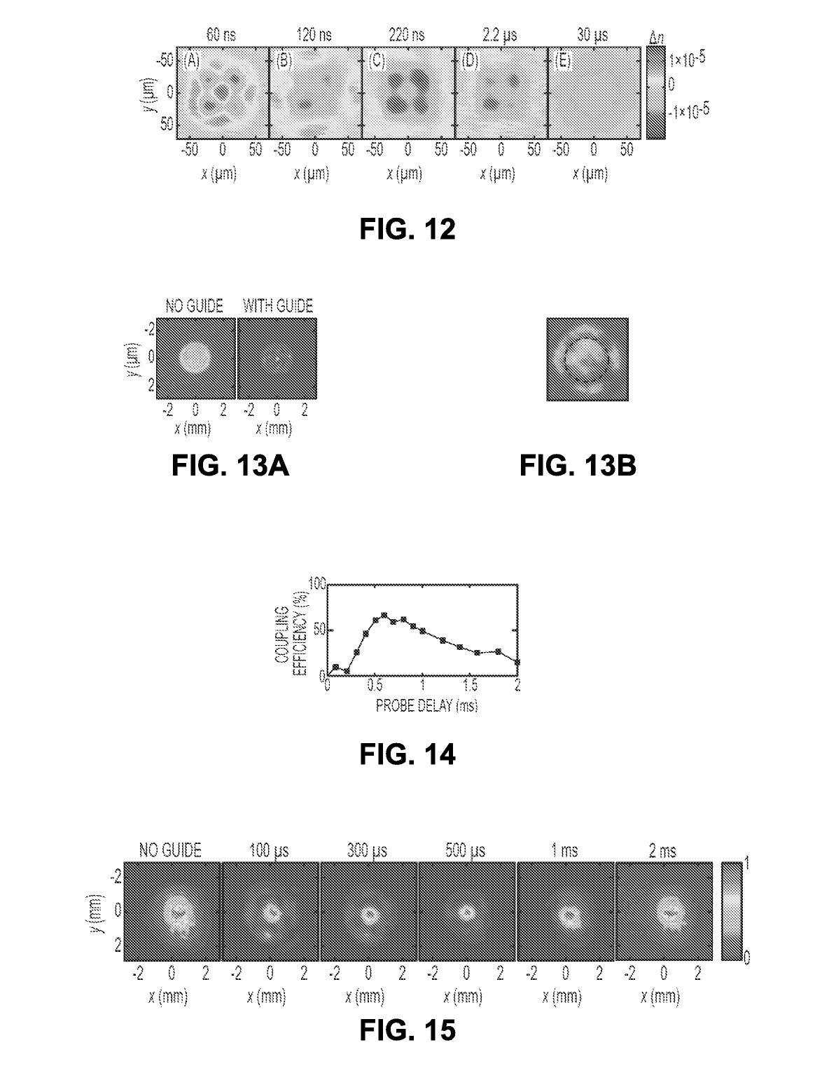

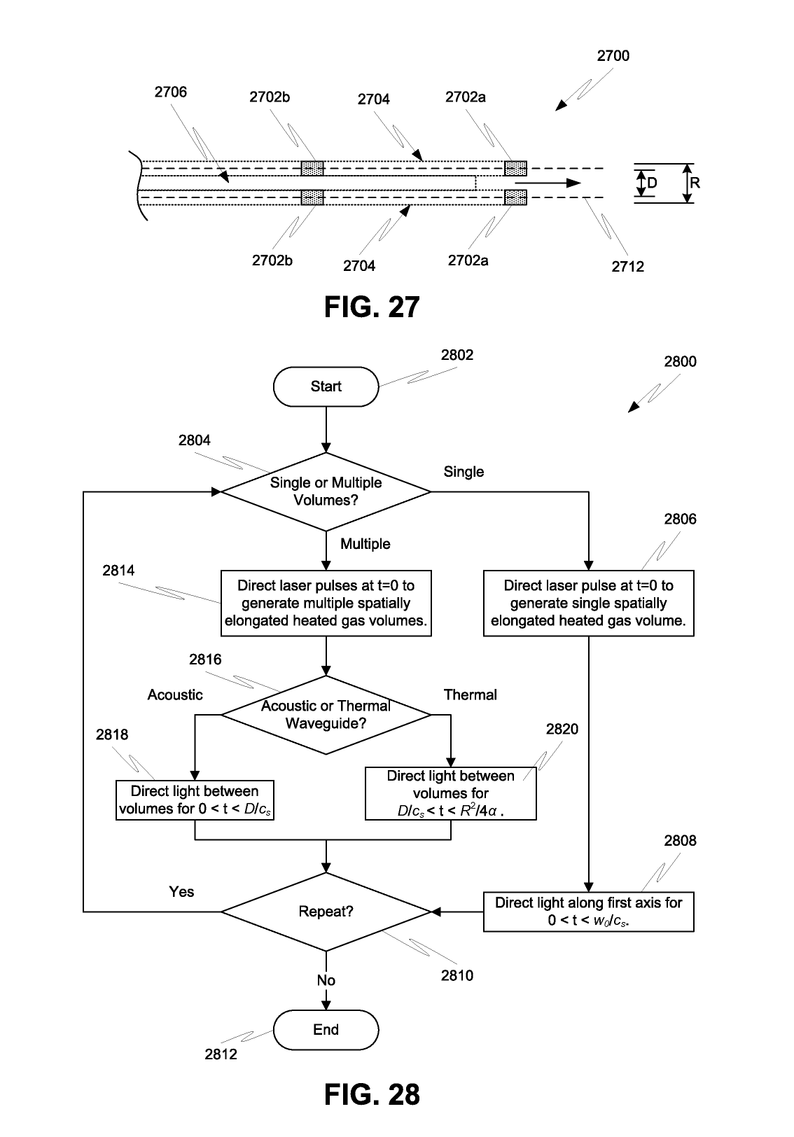

An exemplary effect of a 4-filament structure on the gas dynamics is shown in FIG. 12, which is a sequence of gas density profiles measured for a short (e.g., ˜2 mm) filament (produced at f/35) to minimize refractive distortion of the probe beam. The peak intensity was <10¹⁴ W/cm², typical of the refraction-limited intensity in more extended filaments. As discussed above, there are two regimes, based on the timing following the laser pulse, for the resulting waveguide capable of guiding electromagnetic radiation. A first shorter duration and more transient acoustic regime occurs when the sound waves originating from each of the four filaments superpose at the array's geometric center, as seen in panel (a) of FIG. 12. The superposition of sound waves causes a local density enhancement greater than a single cycle sound wave amplitude (e.g., approximately a factor of two larger than the sound wave amplitude), peaking after filament initiation (e.g., ˜80 ns after filament initiation and lasting approximately ˜50 ns in air). The timing and amplitude values noted above are with respect to a tested embodiment and should not be considered as limiting of embodiments of the disclosed subject matter since such features may depend on various conditions (e.g., gas, density, temperature, sound wavelength, etc.). Indeed, the timing of the acoustic regime will depend on the properties of the medium and can be given by 0<tᵢ≦D/cₛ, where D is the average transverse spacing between the elongated heated gas volumes (i.e., between the filaments, see FIG. 27) and cₛ is the speed of sound in the gas.

A second, longer lasting and significantly more robust thermal regime is achieved tens of microseconds later, well after the sound waves have propagated far from the filaments. In the thermal regime, the gas is in pressure equilibrium. As illustrated in panels (c) and (d) of FIG. 12, thermal diffusion has smoothed the profile in such a way that the gas at center is surrounded by a “moat” of lower density. The central density was lower, even if only slightly, than the far background because its temperature was slightly elevated. Yet the central density was still higher than the surrounding moat. The lifetime of this structure can be on the order of several milliseconds in air. The timing of the thermal regime will, of course, depend on the properties of the medium and is given by D/cₛ<tᵢ<R²/4α, where α is the thermal diffusivity of the gas and R is a transverse length scale of a thermal gas density profile resulting from the spatially elongated heated gas volumes. Note that for many configurations, the value of R can be equal to or approximately equal (e.g., within 10%) to D, since it is the average transverse spacing that generally sets the length scale, for example, as illustrated in FIG. 27.

In both the acoustic and thermal regimes, the diameter of the air waveguide “core” was approximately half the filament lobe spacing. An end mode image from injection and guiding of a low energy λ=532 nm pulse in the acoustic waveguide produced from a 10 cm long 4-filament is shown in FIG. 13A. In order to differentiate between guiding and the propagation of the unguided beam through the fully dissipated guide at later times (>2 ms), the guiding efficiency was defined as (E_{g}−E_{ug})/(Eₜₒₜ−E_{ug}) where E_{g} is the guided energy within the central mode, Eₜₒₜ is the total beam energy and E_{ug} is the fraction of energy of the unguided mode occupying the same transverse area as the guided mode.

In a tested embodiment, best coupling into the acoustic waveguide occurred at an injection delay of ˜200 ns and f/#>100, with a peak guided efficiency of 13%. Efficient guiding in the acoustic regime took place over an injection delay interval of only ˜100 ns, consistent with the time for a sound wave to cross the waveguide core region, a/cₛ˜100 ns, where 2a=75 μm and cₛ˜3.4×10⁴ cm/s is the speed of sound in air. Proper balancing with respect to energy and transverse position of the 4-filament lobes allowed for the superposition of acoustic waves to form a well-defined air waveguide core. These values for the acoustic regime are with respect to a tested embodiment and should not be considered as limiting of embodiments of the disclosed subject matter since features and values may depend on various conditions and system configurations.

By comparison, the thermal guides in the tested embodiment were far more robust, stable, and long-lived. Results from the thermal guide produced by a 70 cm long 4-filament are also shown in FIGS. 13B-15, where optimal coupling was found for f/#=200. An out of focus end mode image (not to scale) is shown in FIG. 13B to verify the presence of the thermal guide's lower density moat. Owing to the much greater lobe spacing of its long 4-filament, the thermal guide of FIG. 13B-15 lasts much longer (e.g., approximately milliseconds) than that from the short 4-filament of FIG. 12 (e.g., approximately 10 μs). Guided output modes as function of injection delay are shown imaged from a plane past the end of the guide, in order to minimize guide distortion of the imaging. Up to 110 mJ of 532 nm light was injected with 90% energy throughput in a single guided mode. This corresponds to a peak guiding efficiency of 70%.

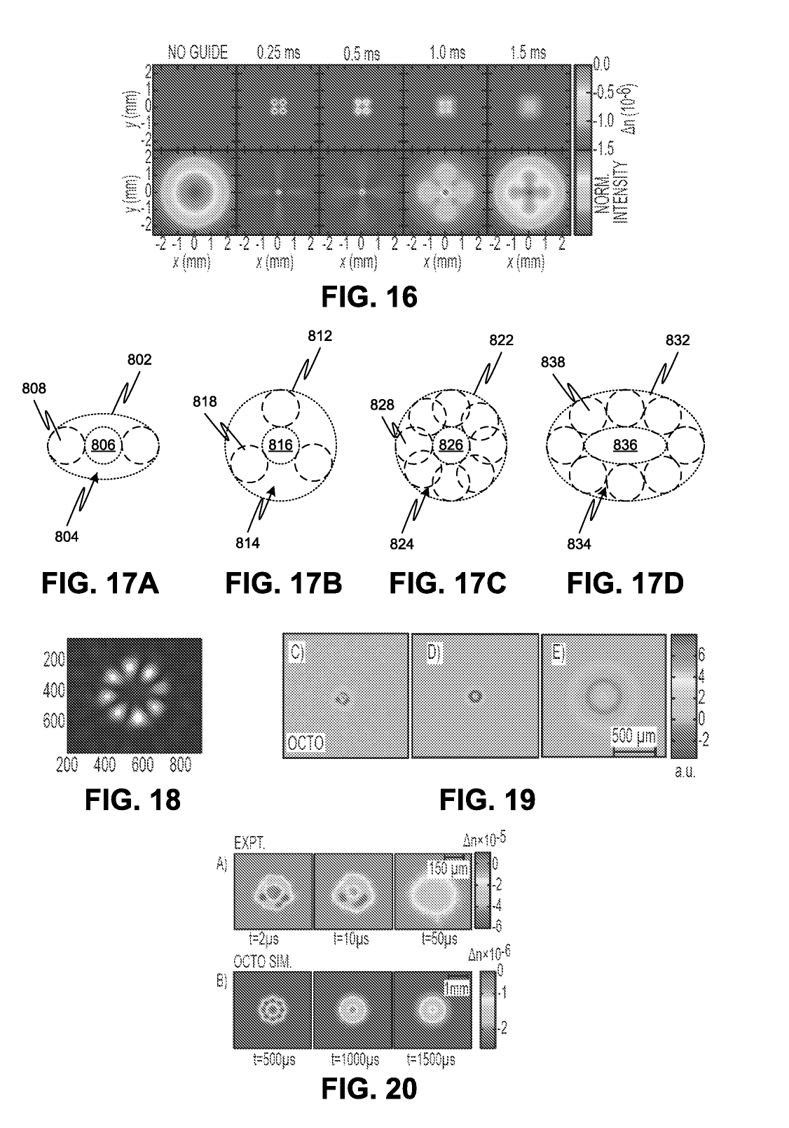

Guiding efficiency versus injected pulse delay is plotted in FIG. 14. As seen in that plot, peak guiding occurs at ˜600 μs and persists out to ˜2 ms where the guiding efficiency drops to ˜15%. Based on the guide core diameter of 2a˜150 μm and the portion of the filament length with constant lobe spacing (e.g., L˜50 cm), the guided beam propagates approximately 15 Rayleigh ranges. The propagation of the 532 nm beam in the waveguide was simulated in the paraxial approximation using the beam propagation method (BPM). The calculated intensity at the output of the waveguide is shown in the lower panels of FIG. 16. At early delays <100 μs, characteristics of a multimode waveguide are observed in the simulation, including mode beating. At later times, as the refractive index contrast decreases, the propagation is smoother, indicating single mode behavior. These values for the thermal regime are with respect to a tested embodiment and should not be considered as limiting of embodiments of the disclosed subject matter since features and values may depend on various conditions and system configurations.

Although an array of four spatially elongated heated gas volumes 206a-206d has been discussed above with respect to FIGS. 9A-9B, embodiments of the disclosed subject matter are not limited thereto and other spatial arrangements and numbers for the elongated heated gas volumes 206 are also possible according to one or more contemplated embodiments. For example, two heated gas volumes 808 can be used to form a waveguiding structure 802 in gas with a higher density core region 806 and a lower density outer region 804, as shown in FIG. 17A. FIG. 17B shows another example where three heated gas volumes 818 are used to form a waveguiding structure 812 in gas with a higher density core region 816 surrounded by a lower density outer region 814. In another example, eight heated gas volumes 828 can be used to form a waveguiding structure 822 in gas with a higher density core region 826 and a lower density annular region 824 surrounding the core region 836, as shown in FIG. 17C.

In each of FIGS. 9A and 17A-17C, the spatially elongated heated gas volumes are disposed at a location equidistant from a center of the waveguide structure and regularly spaced about the center. However, embodiments of the disclosed subject matter are not limited thereto. For example, the heated gas volumes 838 (e.g., eight volumes, although a different number is also possible) can be disposed along an elliptical path to form a waveguiding structure 832 in gas with a higher density core region 836 surrounded by a lower density outer region 834, as shown in FIG. 17D. In each of the examples, the spatially elongated heated gas volumes may be disposed on, or at least form a part of, the periphery of the waveguiding structure. However, other numbers of volumes and configurations are also possible. For example, the waveguiding structure can be substantially planar rather than the circular or elliptical arrangements illustrated in FIGS. 17A-17D. Thus, a higher density planar region may be disposed between a pair of lower density planar regions formed by a pair of linear arrays of elongated heated gas volumes.

In any of these examples or other disclosed embodiments, a waveguide structure in the gas can be formed in a manner similar to the waveguide structure formed by an array of four spatially elongated heated gas volumes described above, for example, by remote focusing of multiple sub-picosecond laser pulses or by using a corresponding array of filaments. For example, FIG. 18 shows an image of an eight lobe beam focus that can produce an array of eight femtosecond filaments for generating the disclosed waveguide structure.

For example, in a multifilament acoustic guide, each of the filaments, equidistant from a common center, launches a single cycle acoustic wave. The interference maximum produced when the waves meet on axis can last τ˜a/cₛ<1 μs, where α is the elongated heated volume diameter, which sets the acoustic wavelength, and cₛ is the speed of sound in the gas. Panels (c) and (d) of FIG. 19 show an interferometric measurement of an octofilament-induced acoustic guide at the moment of peak central index enhancement at delay ˜200 ns and its hydrocode simulation using a ring-shaped pressure source, respectively. Guides as in FIG. 19(c), amenable to longitudinal interferometry, are shorter with tighter transverse spatial features. A hydrocode simulation more representative of axially extended structures used for guiding is shown in panel (e) of FIG. 19 for an initial ring pressure source of radius 200 μm with the same total energy deposition as for 8 filaments.

Row (a) of FIG. 20 shows interferometric measurements of short octo-filament arrays for several times during the evolution of the thermal guide. The three panels resolve distinct stages of the evolution. At t=2 μs the density holes from individual filaments are still distinct. At t=10 μs the holes have merged through thermal diffusion to form a continuous ring. At t=50 μs the holes have diffused to the center and have washed-out the guide. Row (b) of FIG. 20 show scale simulations consistent with longer multi-filaments used in guiding experiments. As can be seen, the relevant timescales increase with the transverse scale size, with guide washout now occurring at >1.5 ms. In contrast with the acoustic regime, the thermal regime produces a much longer lasting guide whose lifetime τₜₕₑᵣₘₐₗ≈R²/4α˜1 ms is set by the thermal diffusivity of the gas (α=19 μm²/μs for air at standard conditions) and the transverse length scale of the guide (e.g., R=500 μm). The above noted values are with respect to specific tested or simulated configurations and should not be considered as limiting of embodiments of the disclosed subject matter since features and values may depend on various conditions and system configurations.

Embodiments of the disclosed subject matter can be used to guide electromagnetic radiation from a source, for example, for conveying radiation to a remote location or for conveying radiation from a remote location. For example, the source of electromagnetic radiation and the optical system configured to generate the waveguide can be co-located, e.g., at an originating end of the waveguide. In another example, the source of electromagnetic radiation and the optical system configured to generate the waveguide can be remote from each other, e.g., with the source at an end of the waveguide opposite to the originating end, for remote detection.

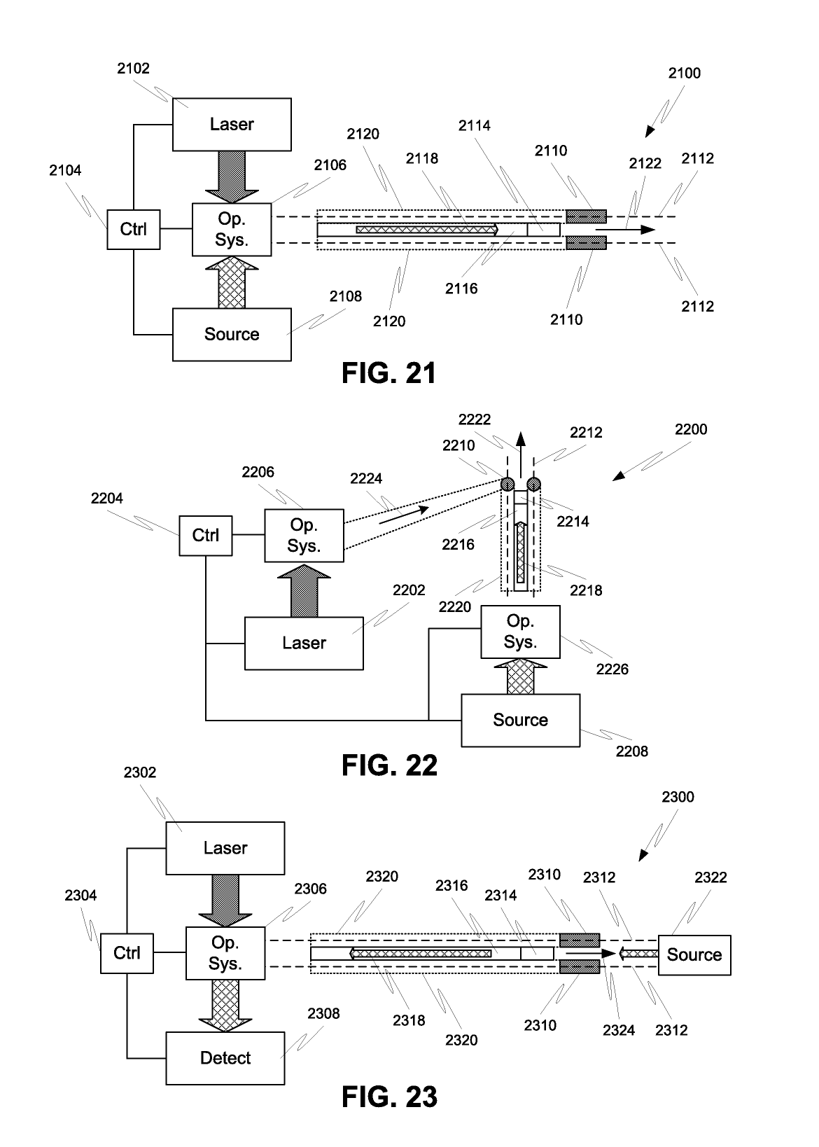

For example, FIG. 21 shows a setup 2100 for conveying electromagnetic radiation 2118 from a secondary source of radiation 2108 using a waveguide in a gas (e.g., the acoustic waveguide 2114 and/or the thermal waveguide 2116) formed by the spatially elongated heated gas volumes 2120 following an array of sub-picosecond filaments 2110. A laser source 2102 can provide one or more laser pulses to an optical system 2106, which conditions and directs the one or more laser pulses along parallel lines of propagation 2112 to form an array of filaments 2110. For example, the optical system 2106 can phase shift segments of a near field phase front of the laser pulse with respect to other segments thereof, to simultaneously form multiple laser pulses using one or more half-pellicles (for example, as described above with respect to FIG. 11) or spatial phase front shifter acting in either reflection mode (for example, using a segmented stepped mirror, as described below) or in transmission mode (for example, using a transparent phase plate). Alternatively or additionally, the optical system 2106 can include a spatial light modulator that can act as a spatial phase front shifter in either reflection mode or transmission mode. Such a spatial light modulator can be programmable (or controlled by control system 2014), for example, to dynamically change the phase front pattern without having to change the modulator and/or other components of the optical system 2106.

The optical system 2106 focuses the multiple laser pulses such that each has a peak power greater than

$${P}_{cr} = \frac{3.77 {λ}^{2}}{8 π {n}_{0} {n}_{2}} ,$$

where λ is the wavelength of each laser pulse, and n₀ and n₂ are the linear and nonlinear indices of refraction of the gas, respectively, so as to form the array of filaments 2110. As explained above, the filaments 2110 are nonlinearly absorbed by the gas as they propagate through the gas, leaving spatially elongated heated gas volumes 2120 in their wake, with the direction of elongation (and the corresponding guiding direction 2122 of the waveguide) following (e.g., substantially parallel to, or at least locally parallel when the waveguide is curved) the direction of propagation 2112 of the filaments 2110. As is apparent from FIG. 21, the lines of propagation 2122 of the filaments can be disposed on the periphery of the waveguide.

A control system 2104 can control operation of the laser source 2102, the secondary radiation source 2108, and/or the optical system 2106. In particular, the control system 2104 can regulate the timing between the filaments 2110 and the secondary radiation 2118 to take advantage of the desired waveguiding regime. For example, the control system controls the time delay, tᵢ, between the filaments and the injected pulse such that 0<tᵢ≦D/cₛ to take advantage of the acoustic waveguiding regime. Because of the longer lifetime of the thermal waveguiding regime, it may be preferable in embodiments for the control system to control the time delay, tᵢ, such that D/cₛ<tᵢ<R²/4α. Alternatively or additionally, the time delay between the filaments and the injected secondary radiation can be controlled via optical system components, for example, by introducing a very long path length delay.

FIG. 22 shows another setup 2200 for conveying electromagnetic radiation 2218 from a secondary source of radiation 2208 using a waveguide in a gas (e.g., the acoustic waveguide 2214 and/or the thermal waveguide 2216) formed by the spatially elongated heated gas volumes 2220 following multiple remotely focused and scanned laser pulses 2210. A laser source 2202 can provide one or more laser pulses to an optical system 2206, which focuses the laser pulses along direction of propagation 2224 to focal volumes 2210 and scans the focal volumes 2210 along respective scan lines 2212. For example, the optical system 2206 can focus and scan the laser pulses as described above with respect to FIGS. 3A-3B and 10A.

The optical system 2206 focuses the multiple laser pulses such that each has a sufficient intensity to cause nonlinear absorption of the laser pulse by the gas. For example, each laser pulse can be concentrated to have an intensity of at least 10¹² W/cm², although other intensity values capable of nonlinear absorption of a laser pulse may also be possible. Following the scanned focal volumes 2210, spatially elongated heated gas volumes 2220 are formed, with the direction of elongation (and the corresponding guiding direction 2222 of the waveguide) following (e.g., substantially parallel to, or at least locally parallel when the waveguide is curved) the direction of scanning 2212 (and crossing the direction of propagation 2224). As is apparent from FIG. 22, the spatially elongated heated gas volumes 2220 can be disposed on the periphery of the waveguide.

A control system 2204 can control operation of the laser source 2202, the secondary radiation source 2208, and/or the optical system 2206. In particular, the control system 2204 can regulate the timing between the focal volume scanning and the secondary radiation 2218 to take advantage of the desired waveguiding regime, for example, as described above with respect to FIG. 21. Alternatively or additionally, the time delay between the focal volume scanning and the injected secondary radiation 2218 can be controlled via optical system components, for example, by introducing a very long path length delay.

Although the setup illustrated in FIG. 22 has been discussed with regard to guiding light from a source controlled by control system 2204, it is also possible to use a similar setup to provide remote detection capability. For example, source 2208 may be remote from laser 2202 and system 2206 and can operate independent of control system 2204, such as when source 2208 originates from a natural or local light source or is induced by laser breakdown. The waveguide in the gas generated by the scanned array of focal volumes can be used to guide radiation from source 2208 at one end of the waveguide to an opposite end of the waveguide, for example, where a detector is located. In such cases, the guided radiation from source 2208 may primarily employ the thermal waveguiding regime 2216, although either waveguiding regime is possible depending on waveguide length and radiation timing. In addition, although the direction of scanning has been illustrated as proceeding in the same direction as injection of the secondary radiation 2216, it is also possible that the scanning and injection directions may be opposite to each other.

In optical stand-off detection techniques, spectroscopic or other light-based quantitative information is collected from a distance. Such schemes can include, but are not limited to, light detection and ranging (LIDAR) and laser-induced breakdown spectroscopy (LIBS). In LIDAR, the signal is induced by a laser pulse, either by reflection or backscattering from distant surfaces or atmospheric constituents. In remote LIBS, laser breakdown of a distant target is accompanied by isotropic emission of characteristic atomic and ionic species. Embodiments of the disclosed subject matter include using a waveguide generated by the nonlinear absorption of a laser pulse (either via scanning a focus as described above with respect to FIG. 22 or using an array of filaments as described below) for conveying light from a remote source, for example, as part of one or more of the above noted optical stand-off detection techniques.

FIG. 23 shows a setup 2300 for detecting electromagnetic radiation 2318 from a secondary source 2322 using a waveguide in a gas (e.g., the acoustic waveguide 2314 and/or the thermal waveguide 2316) formed by the spatially elongated heated gas volumes 2320 following an array of sub-picosecond filaments 2310. A laser source 2302 can provide one or more laser pulses to an optical system 2306, which conditions and directs the one or more laser pulses along parallel lines of propagation 2312 to form an array of filaments 2310 in a manner similar to that described above with respect to FIG. 21. A control system 2304 can control operation of the laser source 2302, the optical system 2306, and/or the detector 2308. In particular, the control system 2304 can regulate the timing between the filaments 2310 and a detection window of the detector 2308 that takes advantage of the desired waveguiding regime.

As explained above, the filaments 2310 are nonlinearly absorbed by the gas as they propagate through the gas, leaving spatially elongated heated gas volumes 2320 in their wake, with the direction of elongation following (e.g., substantially parallel to, or at least locally parallel when the waveguide is curved) the direction of propagation 2312 of the filaments 2310. The waveguide in the gas generated by the array of filaments 2310 can be used to guide radiation 2318 from secondary source 2322 at one end of the waveguide to an opposite originating end of the waveguide, for example, where optical system 2306 or different optical components (not shown) direct radiation 2318 to a detector 2308. The guided radiation 2318 from source 2322 may primarily employ the thermal waveguiding regime 2316, although either waveguiding regime is possible depending on waveguide length and radiation timing. In addition, the direction of propagation 2324 of the filaments 2310 and the direction of propagation of the secondary radiation 2318 may be opposite to each other. Thus, the generated waveguide in the gas can act as an efficient standoff lens.

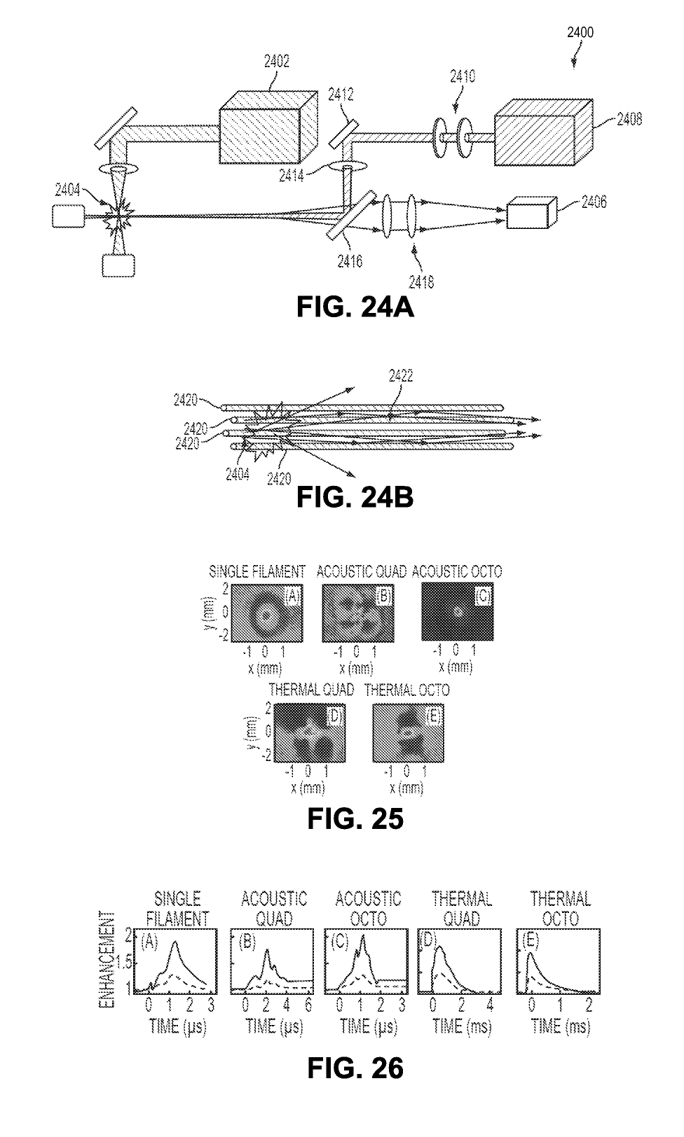

FIGS. 24A-24B illustrate an experimental setup for a waveguide to convey light for remote detection. An array of four filaments 2420, each 75-100 cm long, was generated in air using laser pulses (e.g., 800 nm, 50-100 fs, up to 16 mJ) from a laser 2408 (e.g., Ti:Sapphire) at a frequency of 10 Hz. The beam focusing was varied between f/400 and f/200 depending on the type of guide, e.g., using mirror 2412, focusing lens 2414, and dielectric mirror 2416. An array of four filaments 2420, or quad-filaments, was generated using a phase-shifting optical system 2410 that included two orthogonal “half-pellicles.” Eight-filament arrays were generated using a phase-shifting optical system using an eight-segment stepped mirror. Above the self-focusing threshold, the beam lobes collapse into parallel and distinct filaments. As described above, colliding acoustic waves at the array center launched by the array of filaments forms waveguides 2422 of duration ˜1 μs in air, roughly corresponding to the acoustic wave transit time through the array center. Millisecond lifetime waveguides 2422 develop during the slow post-acoustic thermal diffusion of the density holes left by the filaments. The timing and amplitude values noted above and the results discussed below are with respect to a tested embodiment and should not be considered as limiting of embodiments of the disclosed subject matter since such features may depend on various conditions (e.g., gas, density, temperature, etc.).

The signal collection properties of the waveguides were tested using an isotropic, wide bandwidth optical source containing both continuum and spectral line emission, produced by tight focusing at f/10 of a 6 ns, 532 nm, 100 mJ pulse from a laser 2402 (e.g., a frequency-doubled Nd:YAG laser) to generate a breakdown spark 2404 in air. The air spark laser 2402 and the filament laser 2408 were synchronized with RMS jitter<10 ns. The delay between the spark and the filament structure was varied to probe the time-evolving collection efficiency of the air waveguides. The air spark and filament beams cross at an angle of 22°, so that the spark has a projected length of ˜500 μm transverse to the air waveguide. As depicted in FIG. 24B, the spark 2404 is positioned just inside the far end of the air waveguide 2422. Rays from the source 2404 are lensed by the guide 2422 and an exit plane beyond the end of the guide 2422 was imaged through an 800 nm dielectric mirror 2416 by an imaging lens system 2418 onto a detector 2406 (e.g., CCD camera or the entrance slit of a spectrometer). The exit plane is located within 10 cm of the end of the waveguide 2422.

The collected signal appeared on the CCD image as a guided spot with a diameter characteristic of the air waveguide diameter, as shown in FIG. 25 for five types of air waveguides: the quad-filament and octo-filament waveguides in both the acoustic and thermal regimes, and the single filament annular acoustic guide. Surrounding the guided spots are shadows corresponding to the locations of the gas density depressions, which act as defocusing elements to scatter away source rays. To quantify the air waveguide's signal collecting ability, peak signal enhancement and source collection enhancement were measured. The peak signal enhancement, η₁, is defined as the peak imaged intensity with the air waveguide divided by the light intensity without it, and the source collection enhancement, η₂, is defined as the integrated intensity over the guided spot, divided by the corresponding amount of light on the same CCD pixels in the absence of the air waveguide.

FIG. 26 shows plots of η₁ and η₂ for each of the waveguide types as a function of time delay between the spark and filament laser pulses. Since ˜70% of the spark emission occurs before 500 ns, the evolution of the peak signal and collection enhancements are largely characteristic of the waveguide evolution and not the source evolution. The spot images shown in FIG. 25 are for time delays where the collection efficiency is maximized for each waveguide. In general, η₁>η₂ because the peak intensity enhancement is more spatially localized than the spot.

FIGS. 25-26 illustrate the acoustic and thermal regimes of guiding discussed earlier. In particular, FIGS. 25(b), 25(c), 26(b), and 26(c) illustrate microsecond-duration acoustic guiding in the waveguide formed by colliding sound waves from arrays of four (quad) and eight (octo) filaments. FIGS. 25(d), 25(e), 26(d), and 26(e) illustrate the much longer duration thermal guiding from waveguide structures enabled by the density holes created by the arrays of four and eight filaments. The plots of peak and collection enhancement for the thermal guides show an almost 2 ms long collection window, ˜10³ times longer than for the acoustic guides. In contrast, for a single filament (e.g., as shown in FIGS. 25(a) and 26(a)), source light trapping is possible in a window of ˜1 μs long, where trapping occurs in the positive crest of the single cycle annular acoustic wave launched in the wake of the filament. In such a configuration, the trapping lifetime is constrained by the limited temporal window for source ray acceptance as the acoustic wave propagates outward from the filament. The timing and amplitude values noted above are with respect to a tested embodiment and should not be considered as limiting of embodiments of the disclosed subject matter since such features may depend on various conditions (e.g., gas, density, temperature, etc.).

Embodiments of the disclosed subject matter can combine guiding aspects, for example, as discussed above with respect to FIGS. 21-22, with remote detection, for example, as discussed above with respect to FIGS. 23-24. Thus, the disclosed air waveguides can be dual purpose: not only can they collect and transport remote optical signals, but they can also guide high peak and average power laser drivers to excite those sources.

As discussed above, the acoustic and thermal waveguide regimes are formed in the gas only temporarily following the nonlinear absorption of the sub-picosecond laser pulses. However, the waveguide may be renewed or recreated by repeating the directing of laser pulses at a sufficiently high repetition rate to maintain the guiding thermal gas density profile between the spatial locations of the elongated heated gas profiles. For example, as shown in FIG. 27, at a first time t₁, an array of filaments 2702a can be directed through a gas to generate spatially elongated heated gas volumes 2704 in their wake. The resulting waveguide 2706 is formed between heated gas volumes 2704. Before the waveguide 2706 can dissipate, e.g., before the end of the thermal waveguiding regime, a second array of filaments 2702b can be directed through the gas to cause further heating of the gas volumes 2704 and to maintain the non-uniform density profile between the gas volumes 2704. For example, the rate of repetition can be greater than 4α/R², where α is the thermal diffusivity of the gas and R is a transverse length scale of the thermal gas density profile. A similar repetition scheme can be followed for the waveguide formed by the flying foci embodiments discussed above with respect to FIGS. 3A-3B, 10A, and 22.

For example, based on a single filament diameter of ˜100 μm, an electron density of ˜3×10¹⁶ cm⁻³, ionization energy of ˜10 eV per electron, and 5 meV of heating per air molecule, approximately 0.5 mJ is needed per meter of each filament. With a femtosecond laser system of a few hundred millijoules pulse energy, waveguides hundreds of meters long are possible. Because the disclosed waveguides operating in the thermal formation regime can have long lifetimes (e.g., on the order of milliseconds in air) and a core-to-cladding refractive index difference of a few percent (e.g., at least 1-2%), the waveguides can be used to guide very high average powers that are well below the self-focusing and ionization thresholds.

With regard to thermal blooming from molecular and aerosol absorption in the atmosphere, the deposited laser energy which can raise the local gas temperature by a fraction η of ambient is given by P_{g}Δt/A=1.5ηα⁻¹p, where P_{g} is the guided laser power, Δt is the pulse duration, α is the absorption coefficient, A is the waveguide core cross sectional area, and p is the ambient pressure. Thermal blooming competes with guiding when η is approximately equal to the relative gas density difference between the core and cladding. The index (and density) difference between the core and cladding can be of the order of ˜2% at millisecond timescales. Taking η=0.02, p=1 atm, and α=2×10⁻⁸ cm⁻¹, gives P_{g}Δt/A<˜1.5×10⁵ J/cm² as the energy flux limit for thermal blooming. For example, for a 1.5 mm diameter air waveguide core formed from an azimuthal array of filaments, the limiting energy is P_{g}Δt˜2.7 kJ. If a high power laser is pulsed for Δt˜2 ms, consistent with the lifetime of the 10 Hz-generated thermal waveguides, the peak average power can be 1.3 MW.

In such environments, air heating by the filament array itself could help dissipate the aerosols before the high power beam is injected, raising the thermal blooming threshold and also reducing aerosol scattering. An air waveguide even more robust against thermal blooming and capable of quasi-continuous operation may be possible using a kHz repetition rate filamenting laser. The cumulative effect of filamenting pulses arriving faster than the density hole can dissipate can lead to steady state hole depths of order ˜10%.

Referring to FIG. 28, an exemplary process flow diagram 2800 for generating and using a waveguide in gas is shown. The process starts at 2800 and proceeds to 2804, where it is determined if multiple elongated heated gas volumes or a single elongated heated gas volume will be used. Note that the selection of one option in a particular embodiment does not preclude use of the other option in the same embodiment. Thus, an embodiment using a single elongated heated gas volume to deliver a pulse of interrogating laser light to a remote sample can further include a guide formed by multiple elongated heated gas volumes to convey light from the sample, or vice versa.

If a single volume is selected at 2804, the process proceeds to 2806 where a sub-picosecond laser pulse having or concentrated to have a sufficient intensity (e.g., >10¹² W/cm²) to cause nonlinear absorption is directed through the gas at an initial time, t=0, e.g., as a filament or by remote focusing and scanning of the laser pulse. As described above, the sub-picosecond laser pulse is nonlinearly absorbed by the gas and generates a spatially elongated heated gas volume (e.g., elongated in a direction following the filament propagation direction or in a direction following the scanning of the focal volume). The process then proceeds to 2808 where the secondary radiation (e.g., light) is conveyed by the resulting waveguide (e.g., co-axial with the single elongated heated gas volume) at a time, tᵢ, after the laser pulse is first directed or absorbed by the gas, where

$${t}_{i} < \frac{{w}_{0}}{{c}_{s}} ,$$

w₀ is a spot size of the second pulse, and cₛ is the speed of sound in the gas. For example, tᵢ can be less than 1 μs. When the secondary radiation originates from a same location as the laser pulse of 2806, the timing may be with respect to when the laser pulse is first directed or with respect to a time of the nonlinear absorption of the laser pulse. When the secondary radiation originates from a location different than the laser pulse of 2806 (e.g., in a remote detection setup), the timing may be with respect to a time of the nonlinear absorption of the laser pulse. The process then proceeds to 2810, where it is determined if the process should be repeated. If repetition is desired, the process proceeds to the beginning at 2804; otherwise, the process may terminate at 2812.

If the multiple volume option is selected at 2804, the process proceeds to 2814 where multiple sub-picosecond laser pulses having or concentrated to have a sufficient intensity (e.g., >10¹² W/cm²) to cause nonlinear absorption are simultaneously directed through the gas at an initial time, t=0, e.g., as an array of filaments or by remote focusing and scanning of multiple laser pulses. As described above, the sub-picosecond laser pulses are nonlinearly absorbed by the gas and generate multiple spatially elongated heated gas volumes (e.g., elongated in a direction following the filament propagation direction or in a direction following the scanning of the focal volume). The process then proceeds to 2816, where the desired waveguide regime is selected. If the acoustic regime is selected, the process proceeds to 2818, where the secondary radiation (e.g., light) is conveyed by the resulting waveguide (e.g., co-axial with the single elongated heated gas volume) at a time given by 0<tᵢ≦D/cₛ, where D is the average transverse spacing between the elongated heated gas volumes (i.e., between the filaments, see FIG. 27) and cₛ is the speed of sound in the gas. The process then proceeds to 2810, where it is determined if the process should be repeated. If repetition is desired, the process proceeds to the beginning at 2804; otherwise, the process may terminate at 2812.

If the thermal regime is selected at 2816, the process proceeds to 2820 where the secondary radiation (e.g., light) is conveyed by the resulting waveguide (e.g., co-axial with the single elongated heated gas volume) at a time given by D/cₛ<tᵢ<R²/4α, where α is the thermal diffusivity of the gas and R is a transverse length scale of a thermal gas density profile resulting from the spatially elongated heated gas volumes. For simple array configurations, for example, as illustrated in FIGS. 9B and 17A-17D, the value of R can be equal to or approximately equal (e.g., within 10%) to D, since it is the average transverse spacing that generally sets the length scale, for example, as illustrated in FIG. 27. As noted above, when the secondary radiation originates from a same location as the laser pulses, the timing may be with respect to when the laser pulses are first directed or to a time of the nonlinear absorption of the laser pulses, but when the secondary radiation originates from a location different than the laser pulses (e.g., in a remote detection setup), the timing may be with respect to a time of the nonlinear absorption of the laser pulses. The process then proceeds to 2810, where it is determined if the process should be repeated. If repetition is desired, the process proceeds to the beginning at 2804; otherwise, the process may terminate at 2812.

In embodiments, the repetition rate may be high enough to maintain the desired thermal gas density profile. For example, the repetition rate can be greater than 4α/R² where α is the thermal diffusivity of the gas and R is a transverse length scale of the thermal gas density profile.

Embodiments of the disclosed waveguides and methods can be used for guiding light or other electromagnetic radiation through a gas in a number of applications. For example, the disclosed waveguides can be used to concentrate heater beams for remote atmospheric lasing schemes or for inducing characteristic emission for standoff detection of chemical compounds, as described above. In another example, the disclosed waveguides can be used for remote detection. In many remote detection applications, the collection of fluorescence or other light emission over large distances may be desired, but very little of the isotropically emitted fluorescence or other light emission reaches the detector at a distance. The disclosed waveguides can be used as an effective collection lens, thereby enhancing the detected signal. In another example, the disclosed waveguides could be used in atmospheric laser communication. In still another example, the disclosed waveguides could be used to deliver high power (e.g., >1 MW) over short distances (e.g., <1 m) or over long distances (e.g., >1 m) as part of a laser weapon or optical propulsion system. In yet another example, the disclosed waveguides could be used to enhance and control the propagation of an injected ultrashort filamenting laser pulse. Potential applications for both transmission and collection using the disclosed waveguides include directed energy, lightning control, atmospheric lasing, light detection and ranging (LIDAR), laser-induced breakdown spectroscopy (LIBS), and versions of resonance-enhanced multiphoton ionization (REMPI) spectroscopy. Other examples would be readily apparent to one of ordinary skill in the art.

Various details regarding theory, simulations, and experimental results not explicitly recited herein can be found in one or more of the following publications, which are hereby incorporated by reference herein in their entireties and constitute part of the disclosed subject matter: (1) Cheng et al., “The Effect of Long Timescale Gas Dynamics on Femtosecond Filamentation,” Optics Express, February 2013, 21(4): pp. 4740-51; (2) Jhajj et al., “Demonstration of Long-Lived High-Power Optical Waveguides in Air,” Physical Review X, February 2014, 4:11027; (3) Rosenthal et al., “Collection of Remote Optical Signals by Air Waveguides,” Optica, July 2014, 1(1): pp. 5-9; (4) Jhajj et al., “Optical Mode Structure of the Air Waveguide,” Optics Letters, November 2014, 39(21): pp. 6312-15; (5) Wahlstrand et al., “Direct Imaging of the Acoustic Waves Generated by Femtosecond Filaments in Air,” Optics Letters, March 2014, 39(5): pp. 1290-93.

In one or more first embodiments, a method comprises directing a plurality of propagating laser pulses through a gas. Each of the propagating pulses is formed from the same laser beam or from separate laser beams. The propagating pulses are nonlinearly absorbed by the gas to generate respective spatially elongated heated gas volumes transversely spaced apart from each other. The directing is such that a waveguide is formed in the gas at a location between the heated gas volumes and such that each laser pulse has or is concentrated to have an intensity causing the nonlinear absorption thereof by the gas.

In the first embodiments or any other of the disclosed embodiments, each laser pulse has an intensity of at least 10¹² W/cm² when nonlinearly absorbed by the gas.

In the first embodiments or any other of the disclosed embodiments, the directing the plurality of propagating laser pulses comprises phase-shifting a beam profile of a laser pulse.

In the first embodiments or any other of the disclosed embodiments, the plurality of laser pulses is generated simultaneously. For example, the plurality of laser pulses may be formed and/or directed at an identical time or within 10% of a pulse width of the respective pulses.

In the first embodiments or any other of the disclosed embodiments, the waveguide is formed by interaction between acoustic waves generated from the spatially elongated heated gas volumes, or by a non-uniform thermal gas density profile caused by the spatially elongated heated gas volumes.

In the first embodiments or any other of the disclosed embodiments, the spatially elongated heated gas volumes are on the periphery of the waveguide. For example, the heated gas volumes can surround or at least partially surround a core region of the waveguide, as viewed along a direction of elongation of the gas volumes.

In the first embodiments or any other of the disclosed embodiments, the directing comprises focusing the laser pulses to respective focal volumes, and scanning the focal volumes through the gas to form the spatially elongated heated gas volume. The waveguide extends along a direction of the scanning. The direction of the scanning can be straight or curved.

In the first embodiments or any other of the disclosed embodiments, the scanning comprises phase shifting and/or spectrum shifting laser beams producing said laser pulses to change locations of the corresponding focal volumes.

In the first embodiments or any other of the disclosed embodiments, the laser pulses have a peak power greater than P_{cr} and form a plurality of filaments. The waveguide extends along a direction of propagation of the filaments. P_{cr} satisfies the equation:

$${P}_{cr} = \frac{3.77 {λ}^{2}}{8 π {n}_{0} {n}_{2}} ,$$

where λ is the wavelength of each laser pulse, and n₀ and n₂ are the linear and nonlinear indices of refraction of the gas, respectively. For example, the wavelength can be 800 nm, around 800 nm (e.g., within 10% of 800 nm), or any other wavelength or wavelength range. For example, P_{cr} can be at least 5 GW.

In the first embodiments or any other of the disclosed embodiments, lines of propagation of the filaments are on the periphery of the waveguide. For example, the filaments can surround or at least partially surround a core region of the waveguide, or bound an inner region of the waveguide.

In the first embodiments or any other of the disclosed embodiments, the plurality of filaments comprises an array of filaments generated using a phase-shifting optical system. For example, the phase-shifting optical system can comprise one or more half-pellicles or a spatial phase front shifter acting in either reflection mode (e.g., as a segmented stepped mirror) or transmission mode (e.g., as a transparent phase plate). Alternatively or additionally, the phase-shifting optical system can comprise a spatial light modulator acting as a spatial phase front shifter in either reflection mode or transmission mode.

In the first embodiments or any other of the disclosed embodiments, each laser pulse is less than or equal to 1 ps. For example, the laser pulse can be less than 200 fs or on the order 100 fs.

In the first embodiments or any other of the disclosed embodiments, the method further comprises repeating the directing a plurality of propagating laser pulses at a repetition rate that maintains a thermal gas density profile of the waveguide. The repetition rate can be greater than 4α/R², where α is the thermal diffusivity of the gas and R is a transverse length scale of the thermal gas density profile. For example, the repetition rate can be greater than or equal to 500 Hz, for example, 1 kHz.

In the first embodiments or any other of the disclosed embodiments, the method further comprises at a time, tᵢ, after the directing a plurality of propagating laser pulses or after nonlinear absorption of the propagating laser pulses, injecting electromagnetic radiation from a secondary source into the waveguide formed in the gas.

In the first embodiments or any other of the disclosed embodiments, the time, of the injecting can satisfy either 0<tᵢ<D/cₛ, where D is the average transverse spacing between the elongated heated gas volumes and cₛ is the speed of sound in the gas, or D/cₛ<tᵢ<R²/4α, where α is the thermal diffusivity of the gas and R is a transverse length scale of a thermal gas density profile of the waveguide. For example, R can be equal to or approximately equal to (e.g., within 10% of) D. For example, the time, tᵢ, can be less than 1 μs or between 10 μs and 3 ms, inclusive. For example, the waveguide can have a lifetime of at least 500 μs.

In the first embodiments or any other of the disclosed embodiments, the method further comprises guiding electromagnetic radiation from a source thereof using said waveguide.

In the first embodiments or any other of the disclosed embodiments, the waveguide has a length along a direction of elongation of the heated gas volumes that is at least 1 m, for example, at least tens or hundreds of meters.

In the first embodiments or any other of the disclosed embodiments, the waveguide can convey electromagnetic radiation having a peak average power of at least 1 MW.

In the first embodiments or any other of the disclosed embodiments, the laser pulses are directed at discrete times, i.e., not continuously.

In the first embodiments or any other of the disclosed embodiments, the electromagnetic radiation (e.g., light) guided by the waveguide can be separated in space and/or time from the laser pulses forming the waveguide.

In one or more second embodiments, a system comprises at least one laser that generates sub-picosecond laser pulses, and an optical system that directs the pulses from the at least one laser through a gas such that each laser pulse has or is concentrated to have an intensity causing nonlinear absorption by the gas so as to generate respective spatially elongated heated gas volumes transversely spaced apart from each other.

In the second embodiments or any other of the disclosed embodiments, the laser pulses can have an intensity of at least 10¹² W/cm² when nonlinearly absorbed by the gas.

In the second embodiments or any other of the disclosed embodiments, the at least one laser is constructed to generate pulses at a repetition rate greater than 4α/R² so as to maintain a thermal gas density profile resulting from the spatially elongated heated gas volumes, where α is the thermal diffusivity of the gas and R is a transverse length scale of the thermal gas density profile. For example, R can be equal to or approximately equal (e.g., within 10%) to D.

In the second embodiments or any other of the disclosed embodiments, the system further comprises at least a control system for controlling the at least one laser and/or the optical system.

In the second embodiments or any other of the disclosed embodiments, the system further comprises a control system and a secondary source of electromagnetic radiation. The control system controls a time delay, tᵢ, between the laser pulses from the at least one laser and injection of electromagnetic radiation from said secondary source.

In the second embodiments or any other of the disclosed embodiments, the control system controls the time delay, tᵢ, such that either 0<tᵢ<D/cₛ, where D is the average transverse spacing between the elongated heated gas volumes and cₛ is the speed of sound in the gas, or D/cₛ<tᵢ<R²/4α, where α is the thermal diffusivity of the gas and R is a transverse length scale of a thermal gas density profile resulting from the spatially elongated heated gas volumes is satisfied. For example, R can be equal to or approximately equal (e.g., within 10%) to D.

In the second embodiments or any other of the disclosed embodiments, the system further comprises a waveguide formed in the gas at a location between the spatially elongated heated gas volumes. The spatially elongated heated gas volumes are on the periphery of said waveguide.

In the second embodiments or any other of the disclosed embodiments, the waveguide comprises an enhanced density peak in the gas resulting from collision of acoustic waves generated by the spatially elongated heated gas volumes, and/or a lower density annular region of gas surrounding a higher density core region of gas caused by thermal diffusion in the gas resulting from (and/or including) the spatially elongated heated gas volumes.

In the second embodiments or any other of the disclosed embodiments, the waveguide has a length along a direction of elongation of the heated gas volumes of at least 1 m.

In the second embodiments or any other of the disclosed embodiments, the system further comprises a secondary source of electromagnetic radiation configured to inject electromagnetic radiation into said waveguide and/or a detector configured to detect electromagnetic radiation guided by said waveguide.

In the second embodiments or any other of the disclosed embodiments, the optical system comprises a spectrum-shifting apparatus and/or a phase-shifting apparatus. The phase-shifting apparatus can be constructed to phase shift segments of a near field phase front of the laser pulse with respect to other segments thereof.

In the second embodiments or any other of the disclosed embodiments, the phase-shifting apparatus comprises a half-pellicle and/or a spatial phase front shifter acting either in reflection mode (e.g., as a segmented stepped mirror) or in transmission mode (e.g., as a transparent phase plate) and/or a spatial light modulator acting as a spatial phase front shifter in either reflection mode or transmission mode.

In one or more third embodiments, a waveguide comprises a core region of gas, and an outer region of gas surrounding the core region. The outer region has a density less than that of the core region. The waveguide is formed by directing a plurality of propagating sub-picosecond laser pulses through the gas. The pulses are nonlinearly absorbed by the gas to generate respective spatially elongated heated gas volumes transversely spaced from each other. The waveguide is formed by interaction between acoustic waves generated by the spatially elongated heated gas volumes and/or by a non-uniform thermal gas profile caused by the spatially elongated heated gas volumes.

In the third embodiments or any other of the disclosed embodiments, the outer region of gas is a substantially annular region.

In the third embodiments or any other of the disclosed embodiments, the spatially elongated heated gas volumes are on the periphery of the waveguide.

In the third embodiments or any other of the disclosed embodiments, the waveguide is capable of guiding electromagnetic radiation having a peak average power of at least 1 MW over at least 1 m.

In the third embodiments or any other of the disclosed embodiments, the waveguide is curved along at least a portion of its length and/or is straight along at least a portion of its length.

In one or more fourth embodiments, a method comprises generating a first spatially elongated heated volume in a gas by nonlinear absorption of at least one laser pulse, and using a non-uniform density profile in the gas as a waveguide for electromagnetic radiation. The density profile is caused, at least in part, by the first spatially elongated heated volume.

In one or more fourth embodiments or any other of the disclosed embodiments, each laser pulse has an intensity of at least 10¹² W/cm² when nonlinearly absorbed by the gas.

In one or more fourth embodiments or any other of the disclosed embodiments, the using as a waveguide comprises injecting the electromagnetic radiation into the waveguide so as to be guided thereby.

In the fourth embodiments or any other of the disclosed embodiments, the generating comprises focusing each laser pulse to a focal volume and scanning the focal volumes through the gas to form the first spatially elongated heated volume.

In the fourth embodiments or any other of the disclosed embodiments, the scanning comprises phase shifting and/or spectrum shifting a laser beam producing each laser pulse to change a location of the focal volume.

In the fourth embodiments or any other of the disclosed embodiments, the generating comprises directing a sub-picosecond laser pulse through the gas along a first direction of propagation to form the first spatially elongated heated volume, and the using a non-uniform density profile comprises injecting a further pulse following the sub-picosecond laser pulse along the first direction of propagation at a time, tᵢ, after said directing or after nonlinear absorption of the laser pulse, where

$${t}_{i} < \frac{{w}_{0}}{{c}_{s}} ,$$

w₀ is a spot size of the injected second pulse, and cₛ is the speed of sound in the gas. For example, the injecting may occur on the order of 1 μs after said directing or after the nonlinear absorption of the laser pulse, e.g., 0.1 μs, 1.0 μs, or 10 μs, inclusive, or any time period between 0.1 μs and 10 μs after the directing or nonlinear absorption, depending on gas density and gas type, among other things.

In the fourth embodiments or any other of the disclosed embodiments, the sub-picosecond laser pulse has a peak power greater than P_{cr} and forms a filament along the first direction of propagation, the waveguide extending along the first direction of propagation and following the filament, where

$${P}_{cr} = \frac{3.77 {λ}^{2}}{8 π {n}_{0} {n}_{2}} ,$$

λ is the wavelength of the laser pulse, and η₀ and η₂ are the linear and nonlinear indices of refraction of the gas, respectively.

In the fourth embodiments or any other of the disclosed embodiments, the method further comprises simultaneously with the generating the first spatially elongated heated volume, generating at least a second spatially elongated heated volume in the gas using nonlinear absorption of at least one second laser pulse. The second spatially elongated heated volume is transversely spaced from the first spatially elongated heated volume. The non-uniform density profile in the gas is caused, at least in part, by the first and second spatially elongated heated volumes. The waveguide is formed in the gas between the first and second spatially elongated heated volumes.

In the fourth embodiments or any other of the disclosed embodiments, each second laser pulse has an intensity of at least 10¹² W/cm² when nonlinearly absorbed by the gas.

It will be appreciated that the disclosed modules, processes, or systems associated with forming or use of the waveguide in air may be implemented in hardware, hardware programmed by software, software instruction stored on a non-transitory computer readable medium or a combination of the above. For example, any of the methods or processes disclosed herein can be implemented, for example, using a processor configured to execute a sequence of programmed instructions stored on a non-transitory computer readable medium, which processor and/or computer readable medium may be part of a system configured to form or use said waveguide in air. For example, the processor can include, but is not limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, LabVIEW, or another structured or object-oriented programming language. The sequence of programmed instructions and data associated therewith can be stored in a non-transitory computer-readable medium such as a computer memory or storage device which may be any suitable memory apparatus, such as, but not limited to read-only memory (ROM), programmable read-only memory (PROM), electrically erasable programmable read-only memory (EEPROM), random-access memory (RAM), flash memory, disk drive and the like.

Furthermore, any of the methods or processes disclosed herein can be implemented as a single processor or as a distributed processor, which single or distributed processor may be part of a system configured to form or use said waveguide in air. Further, it should be appreciated that the steps mentioned herein may be performed on a single or distributed processor (single and/or multi-core). Also, any of the methods or processes described in the various figures of and for embodiments herein may be distributed across multiple computers or systems or may be co-located in a single processor or system. Exemplary structural embodiment alternatives suitable for implementing any of the methods or processes described herein are provided below.

Any of the methods or processes described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example, any of which may be part of a system configured to form or use said waveguide in air.

Embodiments of the methods, processes, and systems (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the methods, systems, or computer program products (i.e., software program stored on a non-transitory computer readable medium).

Furthermore, embodiments of the disclosed methods, processes, or systems may be readily implemented, fully or partially, in software using, for example, object or object-oriented software development environments that provide portable source code that can be used on a variety of computer platforms. Alternatively, embodiments of the disclosed methods, processes, or systems can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized. Embodiments of the disclosed methods, processes, or systems can be implemented in hardware and/or software using any known or later developed systems or structures, devices and/or software by those of ordinary skill in the art from the function description provided herein and with knowledge of high power laser systems and/or computer programming arts.

Furthermore, the foregoing descriptions apply, in some cases, to examples generated in a laboratory, but these examples can be extended to production techniques. For example, where quantities, techniques, time scales, and amplitudes apply to the laboratory examples, they should not be understood as limiting. In addition, although specific wavelengths, frequencies, powers, intensities, optical components and/or materials have been disclosed herein, other wavelengths, frequencies, powers, intensities, optical components and/or materials may also be employed according to one or more contemplated embodiments.

Features of the disclosed embodiments may be combined, rearranged, omitted, etc., within the scope of the invention to produce additional embodiments. Furthermore, certain features may sometimes be used to advantage without a corresponding use of other features.

It is thus apparent that there is provided in accordance with the present disclosure, waveguides and systems and methods for forming and using such waveguides. Many alternatives, modifications, and variations are enabled by the present disclosure. While specific embodiments have been shown and described in detail to illustrate the application of the principles of the present invention, it will be understood that the invention may be embodied otherwise without departing from such principles. Accordingly, Applicants intend to embrace all such alternatives, modifications, equivalents, and variations that are within the spirit and scope of the present invention.

1. A method comprising:
directing a plurality of propagating laser pulses through a gas, each of the propagating pulses being formed from the same laser beam or from separate laser beams, the propagating pulses being nonlinearly absorbed by the gas to generate respective spatially elongated heated gas volumes transversely spaced apart from each other,
wherein the directing is such that each laser pulse has, or is concentrated to have, an intensity causing the nonlinear absorption thereof by the gas and such that a waveguide is formed in the gas at a location between the heated gas volumes.

2. The method of claim 1, wherein each laser pulse has an intensity of at least 10¹² W/cm² when nonlinearly absorbed by the gas.

3. The method of claim 1, wherein the directing the plurality of propagating laser pulses comprises phase-shifting a beam profile of a laser pulse.

4. (canceled)

5. The method of claim 1, wherein the waveguide is formed by interaction between acoustic waves generated from the spatially elongated heated gas volumes, or a non-uniform thermal gas density profile caused by the spatially elongated heated gas volumes.

6. (canceled)

7. The method of claim 1, wherein the directing comprises:
focusing the laser pulses to respective focal volumes; and
scanning the focal volumes through the gas to form the spatially elongated heated gas volume, the waveguide extending along a direction of the scanning, said direction of the scanning being straight or curved.

8. (canceled)

9. The method of claim 1, wherein the laser pulses have a peak power greater than P_{cr} and form a plurality of filaments, the waveguide extending along a direction of propagation of the filaments, where
$${P}_{cr} = \frac{3.77 {λ}^{2}}{8 π {n}_{0} {n}_{2}} ,$$
λ is the wavelength of each laser pulse, and n₀ and n₂ are the linear and nonlinear indices of refraction of the gas, respectively.

10-12. (canceled)

13. The method of claim 1, further comprising:
repeating the directing a plurality of propagating laser pulses at a repetition rate that maintains a thermal gas density profile of the waveguide, the repetition rate being greater than 4α/R², where α is the thermal diffusivity of the gas and R is a transverse length scale of the thermal gas density profile.

14. (canceled)

15. The method of claim 1, further comprising:
at a time, tᵢ, after the directing a plurality of propagating laser pulses, injecting electromagnetic radiation from a secondary source into the waveguide formed in the gas,
wherein the time, tᵢ, of the injecting satisfies:
0<tᵢ≦D/cₛ, where D is the average transverse spacing between the elongated heated gas volumes and cₛ is the speed of sound in the gas; or
D/cₛ<tᵢ<R²/4α, where α is the thermal diffusivity of the gas and R is a transverse length scale of a thermal gas density profile of the waveguide.

16. The method of claim 1, further comprising guiding electromagnetic radiation from a source thereof using said waveguide.

17. The method of claim 1, wherein the waveguide has a length along a direction of elongation of the heated gas volumes that is at least 1 m.

18. A system comprising:
at least one laser that generates sub-picosecond laser pulses; and
an optical system that directs the pulses from the at least one laser through a gas such that each laser pulse has or is concentrated to have an intensity causing nonlinear absorption by the gas so as to generate respective spatially elongated heated gas volumes transversely spaced apart from each other.

19. The system of claim 18, wherein the laser pulses have an intensity of at least 10¹² W/cm² when nonlinearly absorbed by the gas.

20. The system of claim 18, wherein the at least one laser is constructed to generate pulses at a repetition rate greater than 4α/R² so as to maintain a thermal gas density profile resulting from the spatially elongated heated gas volumes, where α is the thermal diffusivity of the gas and R is a transverse length scale of the thermal gas density profile.

21. (canceled)

22. The system of claim 18, further comprising:
a control system and a secondary source of electromagnetic radiation, the control system controlling a time delay, tᵢ, between the laser pulses from the at least one laser and injection of electromagnetic radiation from said secondary source,
wherein the control system controls the time delay, tᵢ, such that:
0<tᵢ≦D/cₛ, where D is the average transverse spacing between the elongated heated gas volumes and cₛ is the speed of sound in the gas; or
D/cₛ<tᵢ<R²/4α, where α is the thermal diffusivity of the gas and R is a transverse length scale of a thermal gas density profile resulting from the spatially elongated heated gas volumes.

23-27. (canceled)

28. The system of claim 18, wherein the optical system comprises a spectrum-shifting apparatus or a phase-shifting apparatus constructed to phase shift segments of a near field phase front of the laser pulse with respect to other segments thereof, and the phase-shifting apparatus comprises a half-pellicle, a spatial phase front shifter acting either in reflection mode or in transmission mode, or a spatial light modulator acting as spatial phase front shifter in either reflection or in transmission mode.

29. A waveguide formed by directing a plurality of propagating sub-picosecond laser pulses through a gas, the pulses being nonlinearly absorbed by the gas to generate respective spatially elongated heated gas volumes transversely spaced from each other, the waveguide comprising:
a core region of the gas; and
an outer region of the gas surrounding the core region, the outer region having a density less than that of the core region,
wherein the waveguide is formed by interaction between acoustic waves generated by the spatially elongated heated gas volumes or a non-uniform thermal gas profile caused by the spatially elongated heated gas volumes.

30. (canceled)

31. The waveguide of claim 29, wherein the waveguide is capable of guiding electromagnetic radiation having a peak average power of at least 1 MW over at least 1 m.

32. (canceled)

33. A method comprising:
generating a first spatially elongated heated volume in a gas by nonlinear absorption of at least one laser pulse; and
using a non-uniform density profile in the gas as a waveguide for electromagnetic radiation,
wherein the density profile is caused, at least in part, by the first spatially elongated heated volume.

34-36. (canceled)

37. The method of claim 33, wherein the generating comprises directing a sub-picosecond laser pulse through the gas along a first direction of propagation to form the first spatially elongated heated volume, and the using a non-uniform density profile comprises injecting a second pulse following the sub-picosecond laser pulse along the first direction of propagation at a time, tᵢ, after said directing, where tᵢ<w₀/cₛ, w₀ is a spot size of the injected second pulse, and cₛ is the speed of sound in the gas.

38. The method of claim 37, wherein the sub-picosecond laser pulse has a peak power greater than P_{cr} and forms a filament along the first direction of propagation, the waveguide extending along the first direction of propagation and following the filament, where
$${P}_{cr} = \frac{3.77 {λ}^{2}}{8 π {n}_{0} {n}_{2}} ,$$
λ is the wavelength of the laser pulse, and n₀ and n₂ are the linear and nonlinear indices of refraction of the gas, respectively.

39-40. (canceled)
